(19) United States
(12) Patent Application Publication
(10) Pub. No.: US 2026/0233924 A1
(43) Pub. Date: Aug. 13, 2026

(54) Payload Designs and Payload Wall Designs

(71) Applicant: Ecoatoms, Inc., Reno, NV (US)

(72) Inventors: Pablo Echavarria, Reno, NV (US); Solange Massa, Reno, NV (US)

(73) Assignee: Ecoatoms, Inc., Reno, NV (US)

(21) Appl. No.: 19/151,284

(22) PCT Filed: Jan. 29, 2024
(86) PCT No.: PCT/US24/13373

§ 371 Date: Jul. 25, 2025

Related U.S. Application Data
(60) Provisional application No. 63/481,939, filed on Jan. 27, 2023.

(51) Int. Cl. B65D 88/14; B64G 1/22; B65D 90/04

(52) U.S. Cl. CPC B65D 88/14; B64G 1/22; B65D 90/041

(57) ABSTRACT

The present disclosure generally relates to payload structure systems, and more particularly to payload wall designs and configurations. Payload structures may include a variety of payload walls defining a quadrilateral inner area spanned by a supporting material sheet, and having a number of structural columns aligned and spanning the material sheets. The columns may be arranged 2024/159225 such that the distance between the columns varies across the length of each wall. The distance between each column may also be reduced towards the center of each payload wall. The size shape and number of columns, and the size and shape of the wall may be varied to be suitable for the application. The materials forming the payload wall may also be selected from any material suitable for the selected application.

### CROSS REFERENCE TO RELATED APPLICATIONS

This application claims priority to U.S. Provisional Patent Application No. 63/481,939, filed Jan. 27, 2023 and titled “Payload Designs,” the disclosure of which is incorporated herein by reference in its entirety for all purposes.

### FIELD OF THE INVENTION

The present invention generally relates to payload structure systems. It is more particularly related to payload wall designs and configurations.

### BACKGROUND

Historically space payloads have chosen a square or rectangular shape due to the following reasons: One reason is that square or rectangular shapes are structurally efficient, as they can provide a large surface area for solar panels and other instruments while minimizing the overall mass of the payload. This helps to keep the payload lightweight and reduce launch costs. Another reason is that square or rectangular shapes are easy to package and fit into the payload fairing of a rocket. The fairing is the nose cone that protects the payload during launch. The square or rectangular shape allows for efficient use of the fairing space and minimizes the size of the fairing, which also reduces launch costs. Additionally, square or rectangular shapes are easy to manufacture and assemble, and are also compliant with orbital structures such as the International Space Station National Lab (ISSNL) EXPRESS rack. which can help to reduce costs and improve the overall reliability of the payload. Finally, square or rectangular shapes also allow for a more efficient thermal management, as they allow for a more uniform heat distribution, and also make it easier to design fins or louvers for passive thermal control. Square and/or rectangular shaped payloads are used.

When it comes to the external wall designs aeronautics have gravitated towards a pattern of equally machined squares in the outer wall of the payload. This has helped minimize the flight weight but also increase strength compared to a straight or plain design.

### SUMMARY OF THE INVENTION

In some embodiments, the techniques described herein relate to a payload structure for in-space use. In an embodiment, the payload structure including: a first payload wall including: an outer structure defining a quadrilateral inner area, the inner area spanned by a sheet; a central column structure centrally aligned to and spanning the sheet; and an offset column structure offset from the central column structure towards a first side such that a first distance between the central column structure and the offset column structure is less than a second distance between the offset column structure and a generally parallel portion of the outer structure on the first side.

In another embodiment, the central column structure has a smaller width dimension that the outer structure.

In yet another embodiment, the central column structure has a smaller width dimension that the outer structure.

In still another embodiment, the payload structure further including a second offset column structure, the second offset column structure offset from the central column structure towards a second side such that a third distance between the central column structure and the second offset column structure is less than a fourth distance between the second offset column structure and a second generally parallel portion of the outer structure on the second side, the second side opposite the first side.

In another further embodiment, the payload structure further including a second offset column structure, the second offset column structure offset from the central column structure towards the first side such that the first distance between the central column structure and the offset column structure is less than a third distance between the offset column structure and the second offset column structure, and wherein the third distance is less than a fourth distance from the second offset column structure to the generally parallel portion of the outer structure on the first side.

In another embodiment again, the payload structure further including a central strut structure, the central strut structure centrally aligned to and spanning the sheet, and the central strut structure is generally perpendicular to the central column structure.

In yet still another embodiment, the central strut structure has a smaller width dimension that the outer structure.

In yet another embodiment again, the payload structure further including an offset strut structure offset from the central strut structure towards a first side such that a fifth distance between the central strut structure and the offset strut structure is less than a sixth distance between the central strut structure and a generally parallel portion of the outer structure on a third side.

In still another embodiment again, the payload structure further including a second offset strut structure, the second offset strut structure offset from the central strut structure towards a fourth side such that a seventh distance between the central strut structure and the second offset strut structure is less than an eighth distance between the central strut structure and a fourth generally parallel portion of the outer structure on the fourth side, the fourth side opposite the third side.

In another additional embodiment, the payload structure further including a second offset strut structure, the second offset strut structure offset from the central strut structure towards the third side such that a ninth distance between the central strut structure and the first offset strut structure is less than a tenth distance between the first offset strut structure and the second offset strut structure, and wherein the tenth distance is less than an eleventh distance from the second offset strut structure to the generally parallel portion of the outer structure.

In various embodiments, the techniques described herein relate to a payload wall for in-space use. In an embodiment, the payload wall including: an outer structure defining a quadrilateral inner area, the inner area spanned by a sheet; a central column structure centrally aligned to and spanning the sheet; and an offset column structure offset from the central column structure towards a first side such that a first distance between the central column structure and the offset column structure is less than a second distance between the offset column structure and a generally parallel portion of the outer structure on the first side.

In a further embodiment, the central column structure has a smaller width dimension that the outer structure.

In a still further embodiment, the central column structure has a smaller width dimension that the outer structure.

In yet another further embodiment, the payload wall further including a second offset column structure, the second offset column structure offset from the central column structure towards a second side such that a third distance between the central column structure and the second offset column structure is less than a fourth distance between the second offset column structure and a second generally parallel portion of the outer structure on the second side, the second side opposite the first side.

In another further embodiment, the payload wall further including a second offset column structure, the second offset column structure offset from the central column structure towards the first side such that the first distance between the central column structure and the offset column structure is less than a third distance between the offset column structure and the second offset column structure, and wherein the third distance is less than a fourth distance from the second offset column structure to the generally parallel portion of the outer structure on the first side.

In still another further embodiment, the payload wall further including a central strut structure, the central strut structure centrally aligned to and spanning the sheet, and the central strut structure is generally perpendicular to the central column structure.

In yet still another further embodiment, the central strut structure has a smaller width dimension that the outer structure.

In yet another further embodiment again, the payload wall further including an offset strut structure offset from the central strut structure towards a first side such that a fifth distance between the central strut structure and the offset strut structure is less than a sixth distance between the central strut structure and a generally parallel portion of the outer structure on a third side.

In still another further embodiment again, the payload wall further including a second offset strut structure, the second offset strut structure offset from the central strut structure towards a fourth side such that a seventh distance between the central strut structure and the second offset strut structure is less than an eighth distance between the central strut structure and a fourth generally parallel portion of the outer structure on the fourth side, the fourth side opposite the third side.

In yet still another further additional embodiment again, the payload wall further including a second offset strut structure, the second offset strut structure offset from the central strut structure towards the third side such that a ninth distance between the central strut structure and the first offset strut structure is less than a tenth distance between the first offset strut structure and the second offset strut structure, and wherein the tenth distance is less than an eleventh distance from the second offset strut structure to the generally parallel portion of the outer structure.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIGS. 1A and 1B conceptually illustrate an exemplary payload with distributed supports in accordance with various aspects of the disclosure.

FIG. 2 conceptually illustrates an exemplary rectangular payload wall in accordance with various aspects of the disclosure.

FIG. 3 conceptually illustrates an exemplary square payload in accordance with various aspects of the disclosure.

FIGS. 4A and 4B conceptually illustrate an exemplary payload wall design in accordance with the prior art.

FIGS. 5A and 5B conceptually illustrate an exemplary honeycomb payload wall design in accordance with the prior art.

FIGS. 6A and 6B conceptually illustrate an exemplary progressive rectangular payload wall design in accordance with various aspects of the disclosure.

FIG. 7 conceptually illustrates exemplary simulation data including applied force of a delimited area (4″×4″) in the middle (front force), top and side of the walls) in accordance with various aspects of the disclosure.

FIGS. 8A1, 8A2, 8A3, 8A4, 8A5, 8A6, 8B1, 8B2, 8B3, 8B4, 8B5, 8B6, 8C1, 8C2, 8C3, 8C4, 8C5, and 8C6 show data from structural mechanical simulations (e.g., simulations performed using COMSOL) showing stress and/or displacement in accordance with various aspects of the disclosure.

FIGS. 9A1, 9A2, 9A3, 9A4, 9B1, 9B2, 9B3, 9B4, 9C1, 9C2, 9C3, and 9C4 show data from structural mechanical simulations (e.g., from COMSOL) showing stress simulations data for a front force applied to a plain wall (FIGS. 9A1, 9A2, 9A3, and 9A4), a hex wall (FIGS. 9B1, 9B2, 9B3, and 9B4) and a payload wall (FIGS. 9C1, 9C2, 9C3, and 9C4) in accordance with various aspects of the disclosure.

FIGS. 10A1, 10A2, 10A3, 10A4, 10B1, 10B2, 10B3, 10B4, 10C1, 10C2, 10C3, and 10C4 show data from structural mechanical simulations (e.g., from COMSOL) showing stress simulations data for a side force applied to a plain wall (FIGS. 10A1, 10A2, 10A3, and 10A4), a hex wall (FIGS. 10B1, 10B2, 10B3, and 10B4) and a payload wall (FIGS. 10C1, 10C2, 10C3, and 10C4) in accordance with various aspects of the disclosure.

FIGS. 11A1, 11A2, 11A3, 11A4, 11B1, 11B2, 11B3, 11B4, 11C1, 11C2, 11C3, and 11C4 show data from structural mechanical simulations (e.g., from COMSOL) showing stress simulations data for a top force applied to a plain wall (FIGS. 11A1, 11A2, 11A3, and 11A4), a hex wall (FIGS. 11B1, 11B2, 11B3, and 11B4) and a payload wall (FIGS. 11C1, 11C2, 11C3, and 11C4) in accordance with various aspects of the disclosure.

FIGS. 12A through 12C provide force diagrams of an example payload wall with supports in accordance with various aspects of the disclosure.

FIGS. 13A through 13C provide force diagrams of an example payload wall with supports and a distributed applied force in accordance with various aspects of the disclosure.

FIGS. 14A through 14B provide force diagrams of an example wall with progressive square supports in two directions and distributed applied forces in accordance with various aspects of the disclosure.

FIG. 15 shows an example distribution for stress in response to a point load on a payload wall with no columns in accordance with various aspects of the disclosure.

FIG. 16A and FIG. 16B respectively provide example distributions for stress in response to a point load and a distributed load on a payload wall with one column in accordance with various aspects of the disclosure.

FIG. 17 shows an example distribution for stress in response to a distributed load on a payload wall with three columns.

FIG. 18 shows an example distribution for stress in response to a distributed load on a payload wall with five columns.

FIG. 19A through 19B respectively show distributions for stress in response to an offset distributed load on a payload wall with five columns and a payload with other walls shown in accordance with various aspects of the disclosure.

### DETAILED DESCRIPTION

Turning to the figures, the present disclosure generally relates to payload structure systems, and more particularly to payload wall designs and configurations. In various embodiments payload structures may include a variety of payload walls defining a quadrilateral inner area spanned by a supporting material sheet, and having a number of structural columns aligned and spanning the material sheets. In many embodiments the columns are arranged such that the distance between the columns varies across the length of each wall. In various embodiments the distance between each column reduces towards the center of each payload wall. Some embodiments are directed to payload walls for in-space use comprising a material sheet and a series of column structures configured to span the sheet, wherein the distance between the column structures increases outward from the central point of the payload wall. In many embodiments the size shape and number of columns and the size and shape of the wall may be varied to be suitable for the application. The materials forming the payload wall according to embodiments may also be selected from any material suitable for the selected application.

As previously discussed, conventional space payload designs have relied on square or rectangular shaped walls and supports for a number of reasons. One reason is that square or rectangular shapes are structurally efficient, as they can provide a large surface area for solar panels and other instruments while minimizing the overall mass of the payload. This helps to keep the payload lightweight and reduce launch costs. As a result of the near universal adoption of these design philosophies, alternatives have not been explored. In particular, little work has been done to explore modifications of these designs that might minimize weight and decrease impact damage at weak points.

The current disclosure is directed to payload structures where not every part of the wall will have the same strength and/or be impacted equally. Embodiments of the disclosure demonstrate that distributing columns and/or supports in higher frequency towards the impact zone can lead to improved payload structures: increasing the stiffness and strength of the structure in the area where it is most likely to experience high loads or impacts; helping to redistribute and absorb the energy of the impact, reducing the likelihood of damage or collapse; and improving the overall stability and/or durability of the structure, helping to prevent failure or collapse while minimizing flight weight.

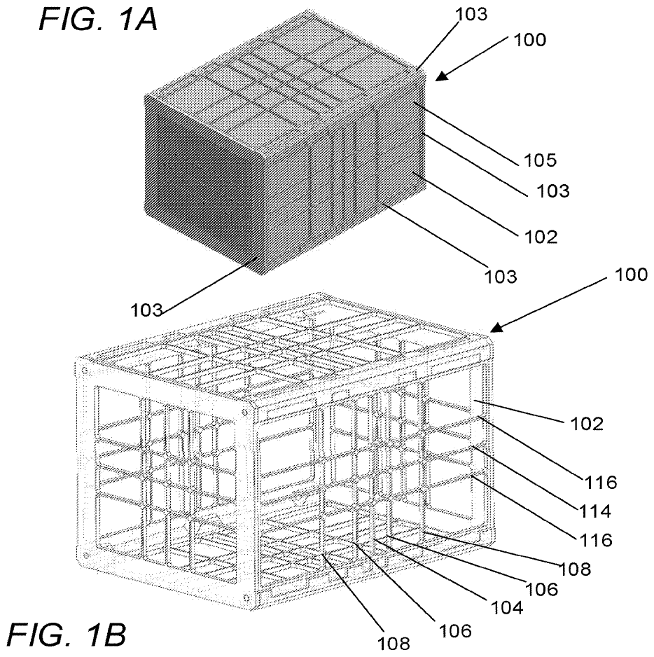

An exemplary embodiment of a payload with distributed supports in accordance with the disclosure is conceptually illustrated in FIGS. 1A and 1B. The payload shown in FIGS. 1A and 1B can be referred to as a full patterned payload. The payload 100 can include payload walls 102. The payload walls 102 can have an outer structure 103 that defines a quadrilateral area. The quadrilateral area can be spanned by a sheet 105. One or more of the sides can have a column design. The column design can be a half to half to half column design in the payload's wall pattern distribution that progresses in halves from the edges towards the center of the payload (e.g., where the weakest impact point would otherwise lie). For a rectangular side there can be a centered column 104, two first off-centered columns 106, and two second off-centered (e.g., offset) columns 108. For the rectangular side, there can be a centered strut 114, and two first off-centered struts 116. The columns and struts of a payload wall can be generally perpendicular to each other and/or can be generally perpendicular to an edge of the payload wall. In several embodiments, second off-centered columns can be further spaced from the centered column than first off-centered columns. In many embodiments, a spacing pattern goes as follows for rectangular shapes: 4, 2, 1, 1, 2, 4 supporting a long edge, and/or 2,1,1,2 for supporting a short edge. In several embodiments, column structures and/or strut structures can be smaller (e.g., have smaller widths and/or diameters) than the outer structure.

While specific systems for payload walls are described above, any of a variety of systems and configurations can be utilized as a payload and/or payload wall as appropriate to the requirements of specific applications. In certain embodiments, components may be configured in any order, sequence, and/or configuration not limited to the order, sequence and/or configuration shown and described. In some embodiments, one or more of the components can be rearranged or omitted. Although the above embodiments of the invention are described in reference to a payload wall, the techniques disclosed herein may be used in any type of structural system.

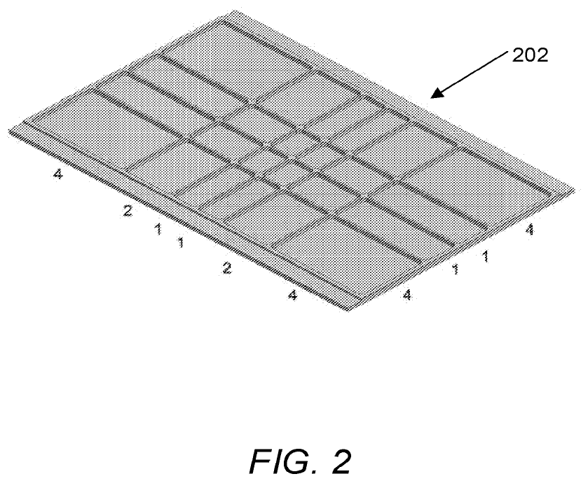

An exemplary embodiment of rectangular payload wall according to the disclosure is conceptually illustrated in FIG. 2. The payload wall 202 shown has a spacing pattern that goes as follows for rectangular shapes: 4, 2, 1, 1, 2, 4 supporting a long edge, and/or 2,1,1,2 for supporting a short edge. The spacing is indicated on the figure.

While specific systems for payload walls are described above, any of a variety of systems and configurations can be utilized as a payload and/or payload wall as appropriate to the requirements of specific applications. In certain embodiments, components may be configured in any order, sequence, and/or configuration not limited to the order, sequence and/or configuration shown and described. In some embodiments, one or more of the components can be rearranged or omitted. Although the above embodiments of the invention are described in reference to a payload wall, the techniques disclosed herein may be used in any type of structural system.

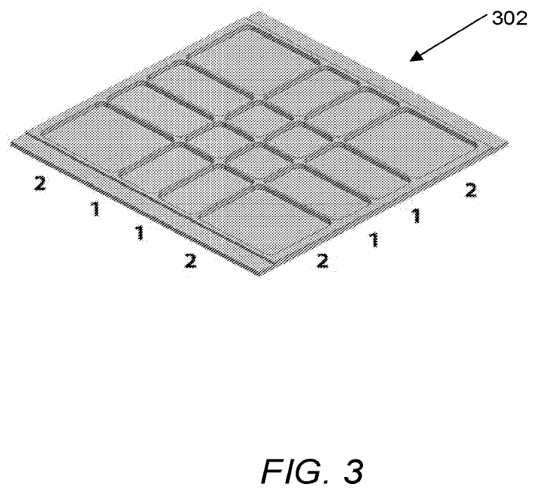

An exemplary embodiment of a square payload wall in accordance with the disclosure is conceptually illustrated in FIG. 3. The payload wall 302 shown has a spacing pattern that goes as follows on a first side 2, 1, 1, 2 and on the second side 2, 1, 1, 2.

While specific systems for payload walls are described above, any of a variety of systems and configurations can be utilized as a payload and/or payload wall as appropriate to the requirements of specific applications. In certain embodiments, components may be configured in any order, sequence, and/or configuration not limited to the order, sequence and/or configuration shown and described. In some embodiments, one or more of the components can be rearranged or omitted. Although the above embodiments of the invention are described in reference to a payload wall, the techniques disclosed herein may be used in any type of structural system.

In several embodiments, the dimensions and/or number of struts and/or columns can be different from those depicted. A payload wall can be of a great many dimensions and can have a wide range of numbers of columns and/or struts. In accordance with various embodiments of the disclosure, payload walls can have surfaces covered by various numbers of columns, struts and/or supports. In some embodiments, the minimum area covered by columns or supports for a square or rectangle payload in order to withstand the force applied is at least about 9.48% of the surface area of the square, and/or at least about 8.63% of the surface area of the rectangle. In various embodiments, the columns width can be augmented or varied at any point and according to the requirement of each payload. There is also the consideration of payload weight so, in some embodiments, the column surface provided is the minimum to withstand the force to maintain a minimum viable weight.

The payload wall design in accordance with many embodiments shows advantages compared to previous payload designs and/or as compared to plain wall designs. In particular, payload walls, in accordance with various embodiments, can provide improvements in at least adaptability, force distribution, weight, among others. Adaptability can refer to an adaptability to several form factors (including several sizes) using a single mathematical design principle. Force distribution can refer to specific shape for impact force distribution performance. Example stress distributions for some example payload and payload wall designs are provided elsewhere in this document. The design can be lightweight compared to unpatterned surfaces.

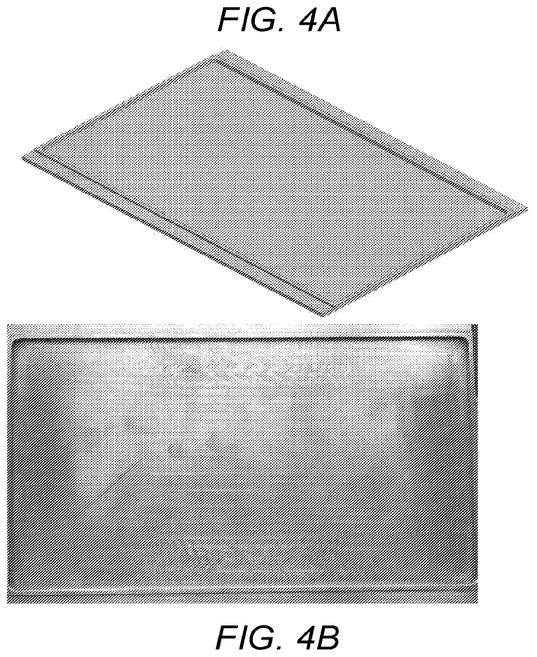

An example of a prior art plain design is conceptually illustrated in FIGS. 4A and 4B. A plain design with an unpatterned wall can have the following characteristics: a wall machined out of a 3/16″ plate with ⅛″ side rails and center wall thickness of 3/64″. Such a payload wall can be used as a basis for comparison to various embodiments described herein.

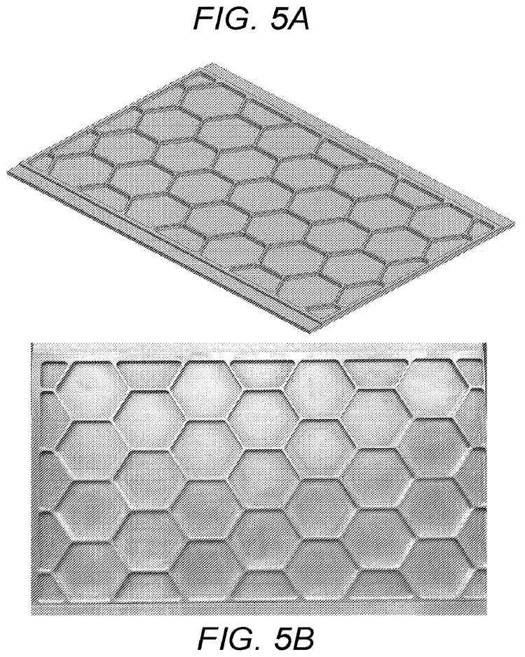

An example of a honeycomb design is conceptually illustrated in FIGS. 5A and 5B. A hexagon pattern wall can have the following characteristics: walls machined out of a 3/16″ plate with ⅛″ side rails, 1.75″ hexagon size and wall thickness of 3/64″. Such a payload wall can be used as a basis for comparison to various embodiments described herein.

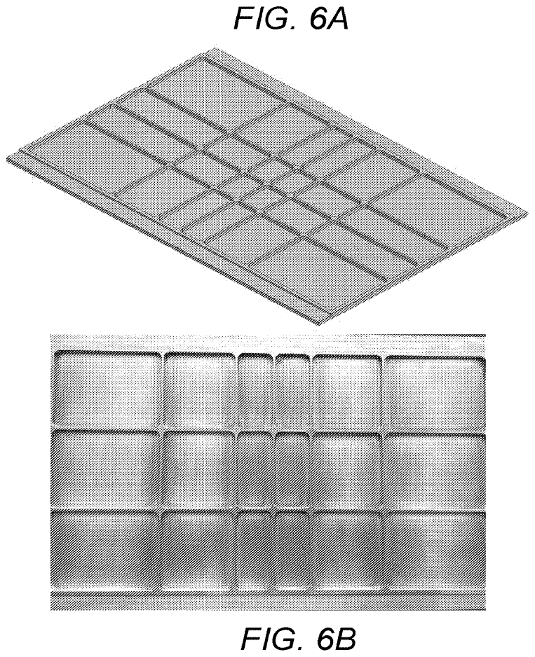

An example of a progressive rectangular payload wall design in accordance with various embodiments is conceptually illustrated in FIGS. 6A and 6B. A strutted, columned, and/or progressive rectangular patterned payload wall in accordance with various embodiments can have the following characteristics in accordance with embodiments of the invention: wall machined out of a 3/16″ plate with ⅛″ side rails, wall thickness of 3/64″ and/or variable rectangle height and/or width. In order to assess the advantage of a variable payload wall design in accordance with various embodiments (e.g., such as the payload wall design shown in FIGS. 6A/6B) compared to a conventional plain wall (e.g., as shown in FIGS. 4A/4B) and a conventional honeycomb wall (e.g., as shown in FIGS. 5A/5B)), simulations can be performed.

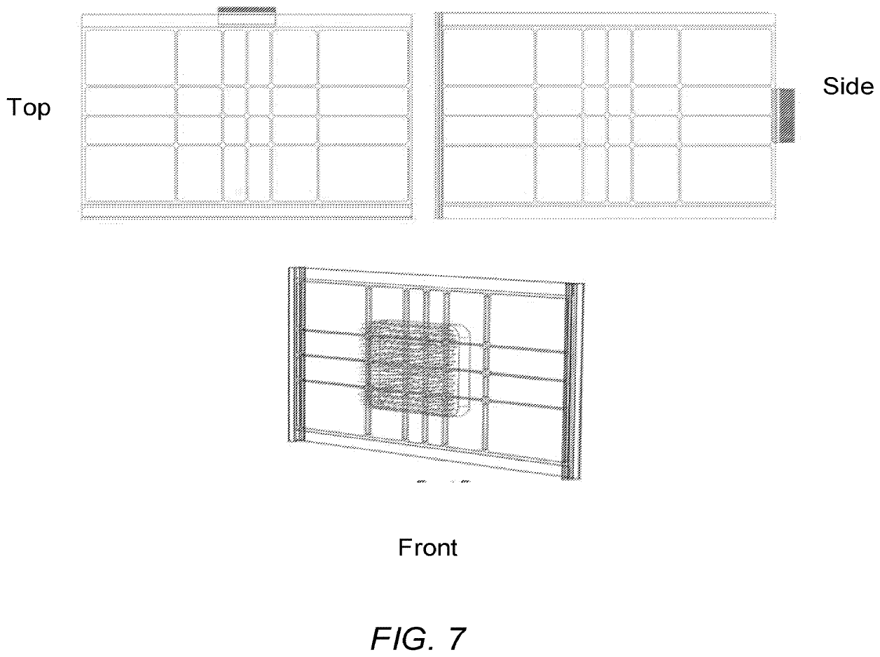

An example simulation (e.g., using COMSOL) comprising applying a force to a delimited area (4″×4″) in the middle (front force), top and side of the walls) is shown in FIG. 7. Per NASA specification and in anticipation of the development of an ISSNL payload, the example tested wall (e.g., a payload wall which is consistent with the embodiments of the variable payload wall of the disclosure as shown in FIGS. 6A/6B) was designed to withstand a force of 125 lbf applied over a 4-inch by 4-inch area (per NASA ISS locker specs-Table 4.5.1-1-SSP-52000-idd-erp). Various embodiments of the invention can be implemented so as to be consistent with the various analysis and/or data presented throughout this document and associated figures. Several embodiments comply with the NASA ISS locker specs.

In some embodiments, in order to simulate the forces, COMSOL was configured with a boundary load of around 125 lbf that can damage the payload and to understand the stress behavior on each pattern the software COMSOL was used to generate these studies. In FIG. 7, the red bars and the central square are the forces applied to the walls in the three patterns and they are defined as top force, side force and front force respectively.

The impact force study was performed using the Structural Mechanics module. The wall models were imported to COMSOL as well as the defined the geometry, material properties, and boundary load conditions. Then a Structural Mechanics module and set up a von Mises stress was used. The simulation was performed to obtain results such as first principal stress and displacement magnitude as a function of different boundary loads scenarios and analyzed the results for maximum displacement and max stress.

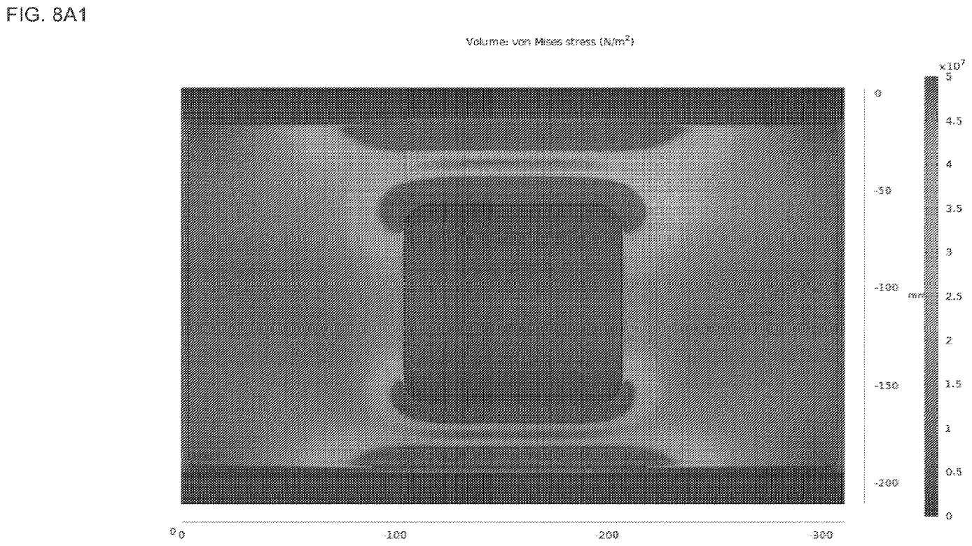

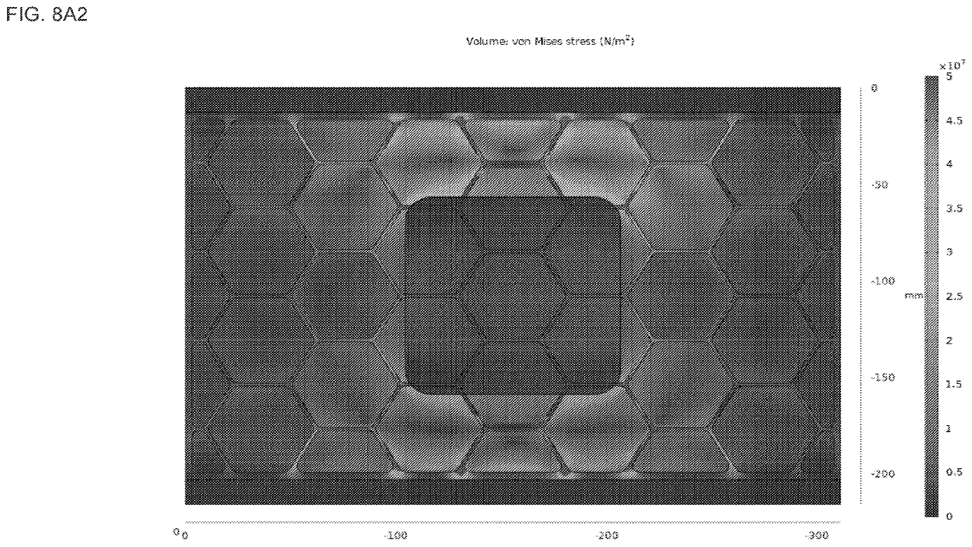

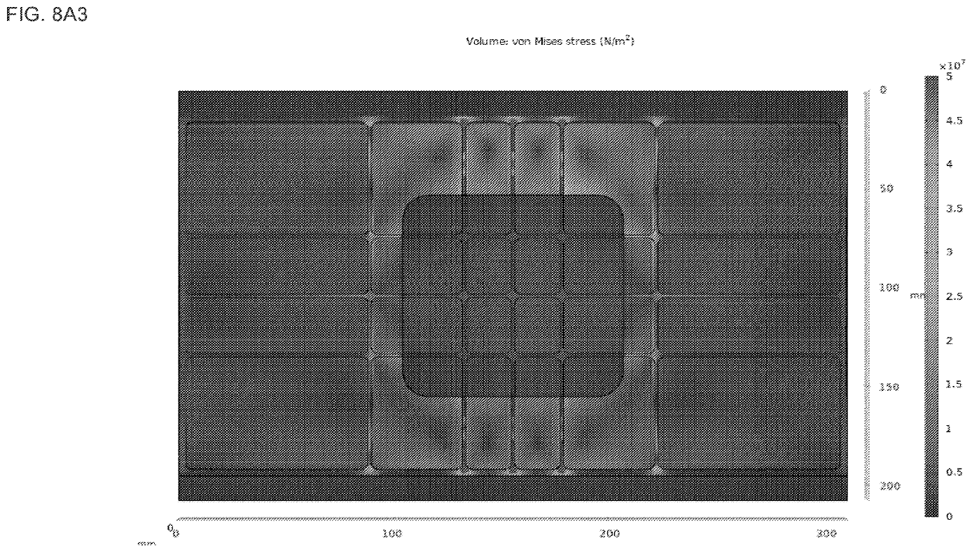

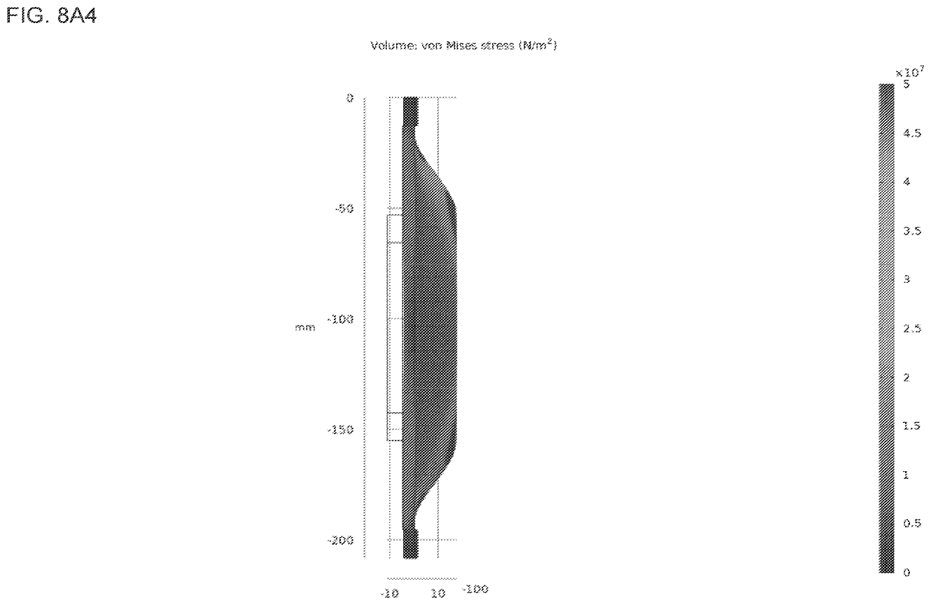

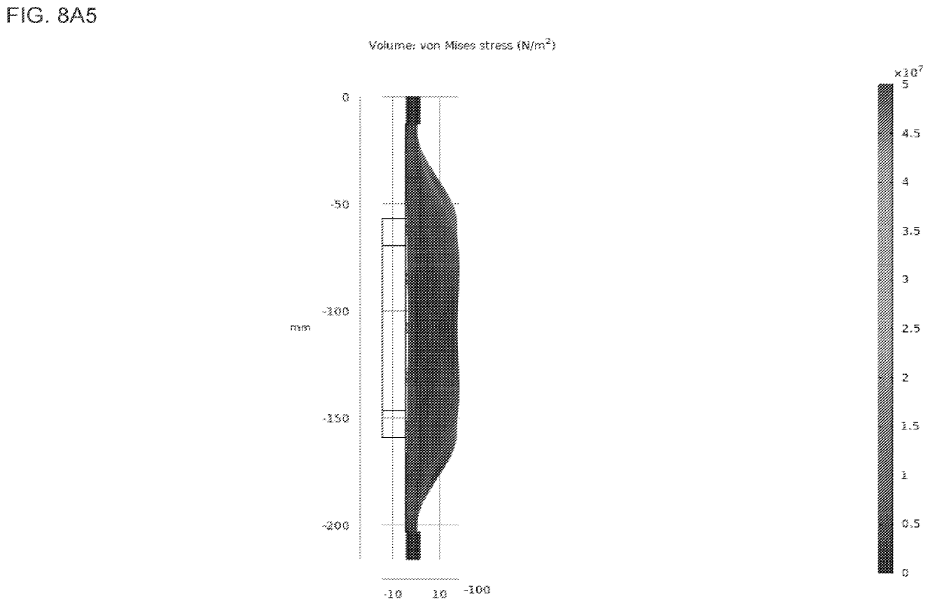

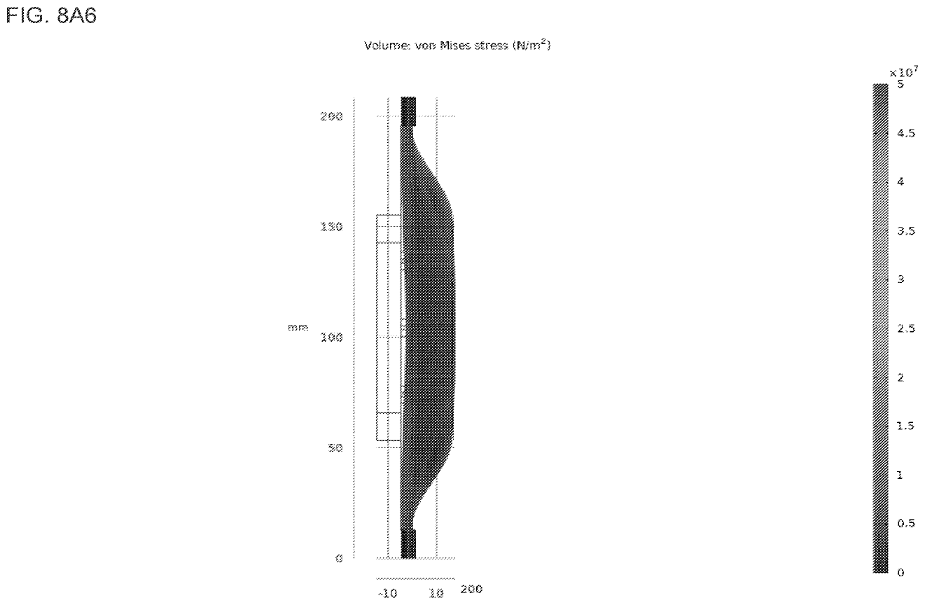

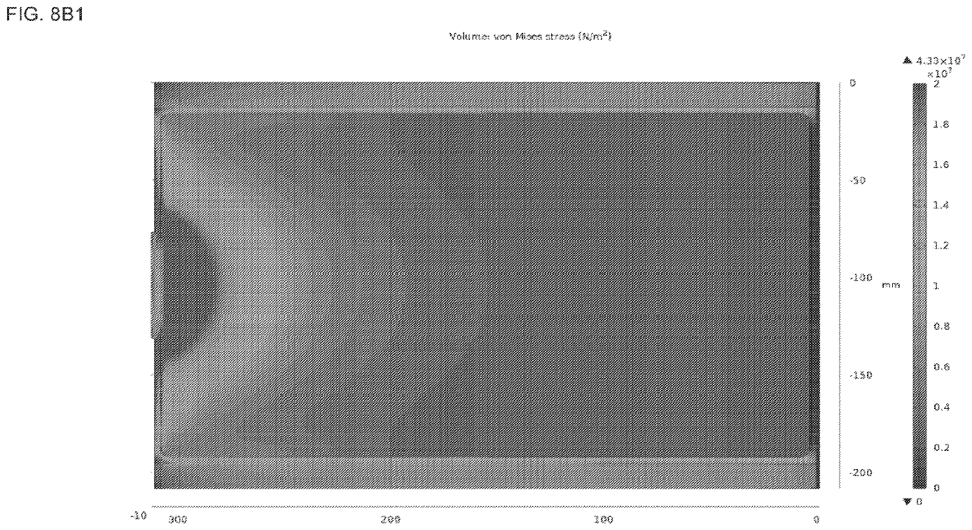

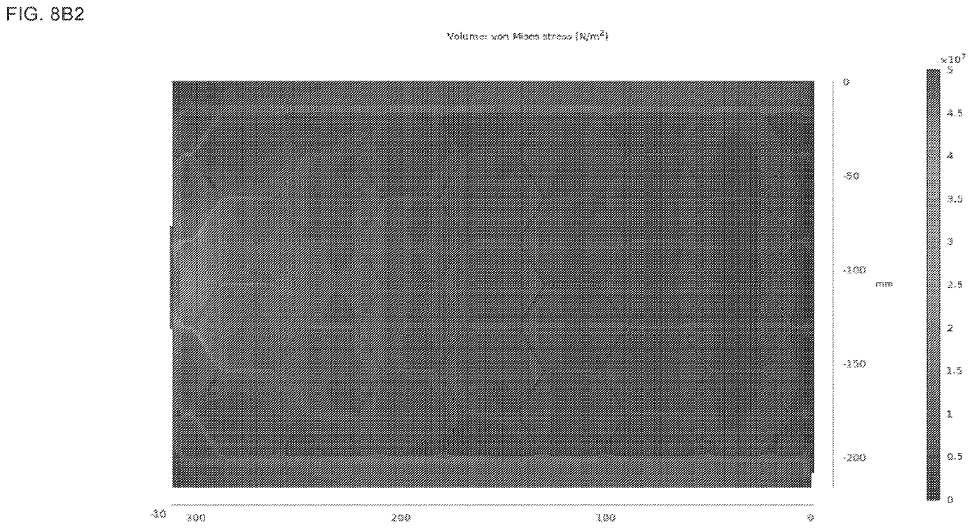

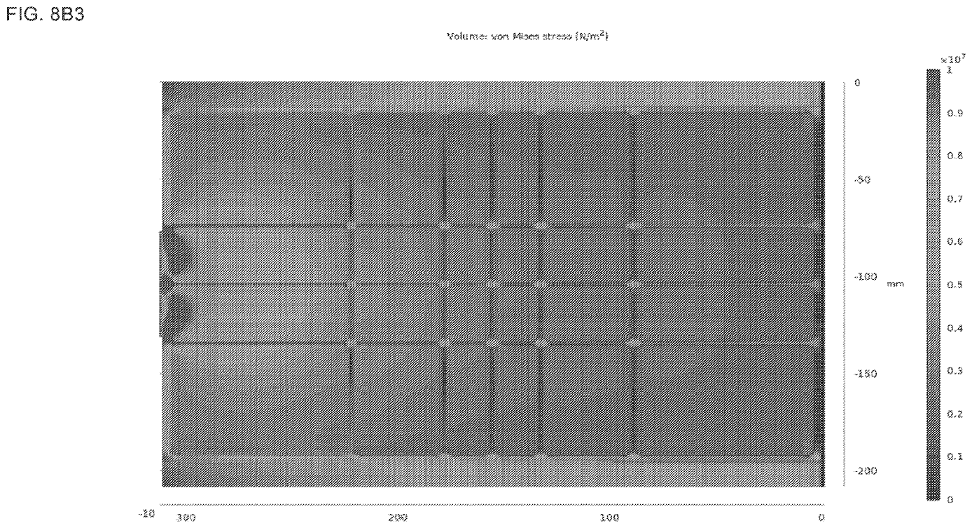

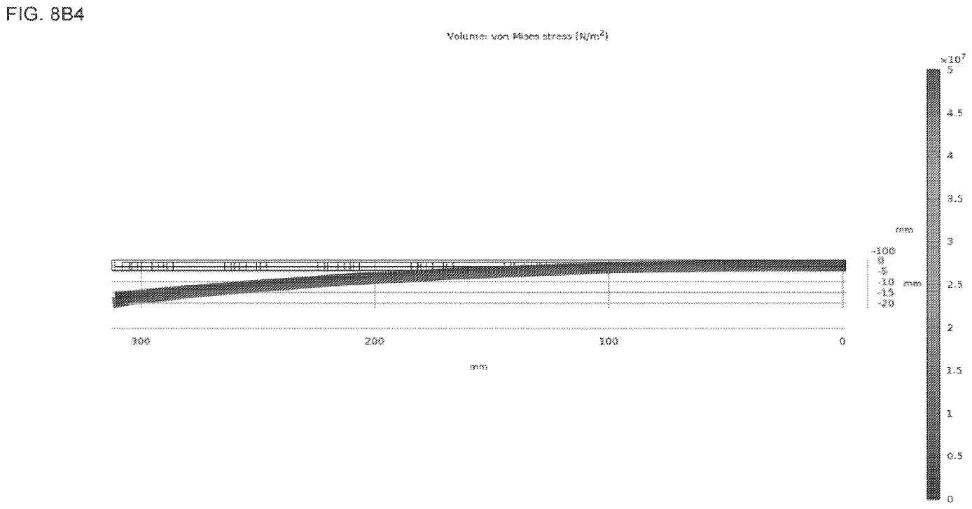

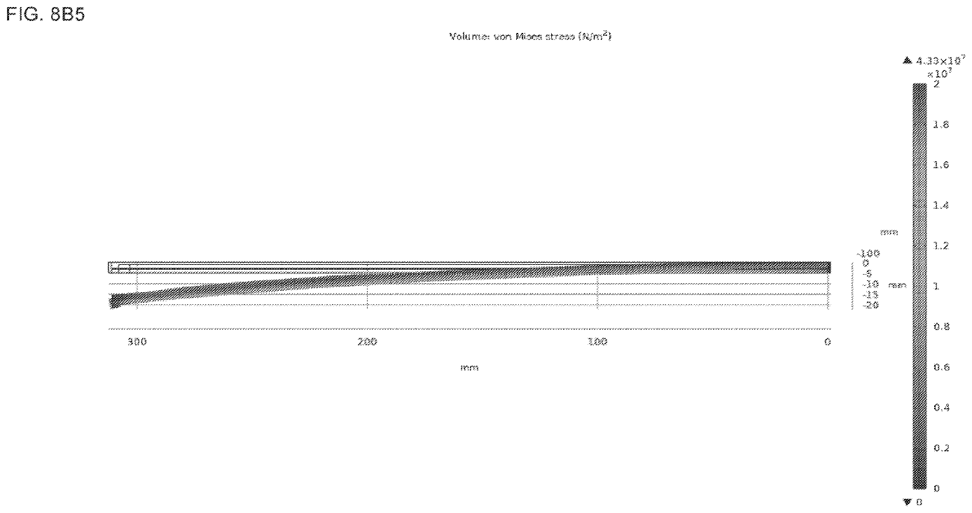

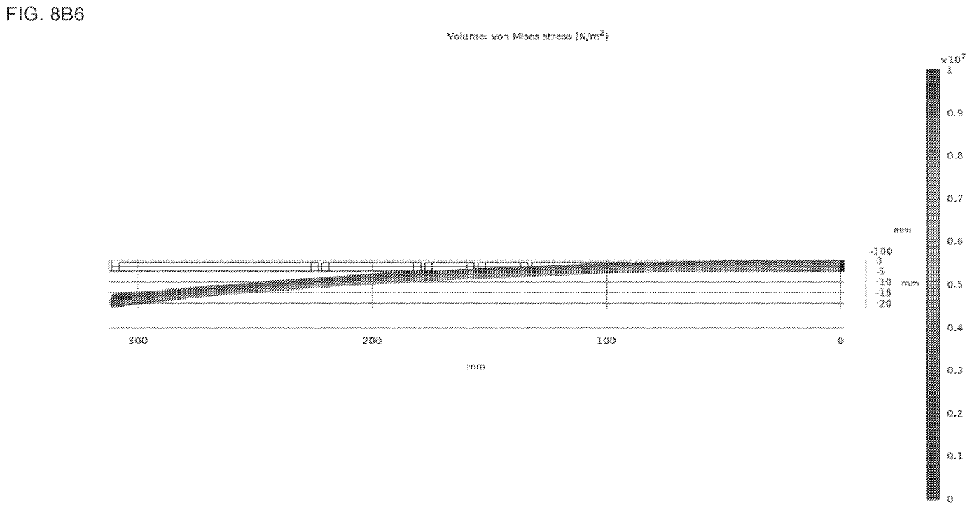

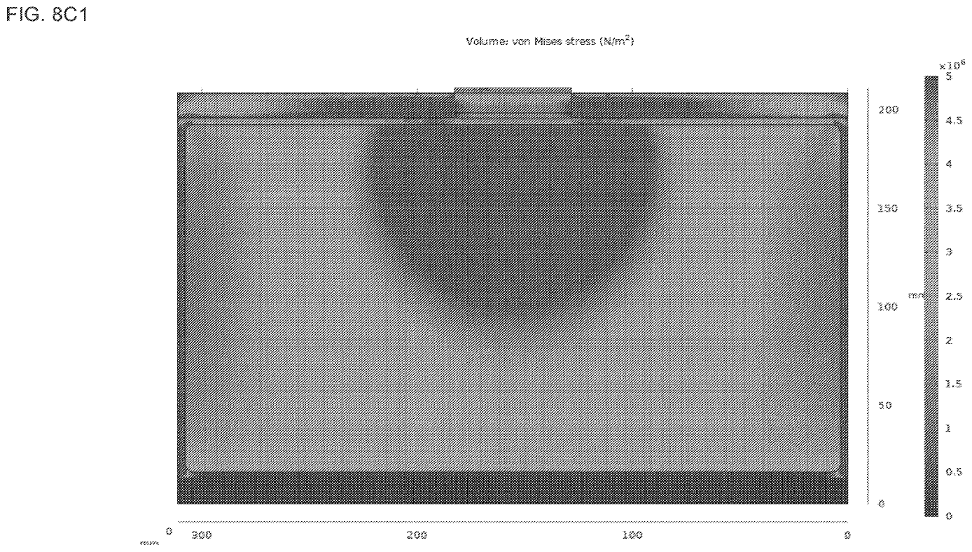

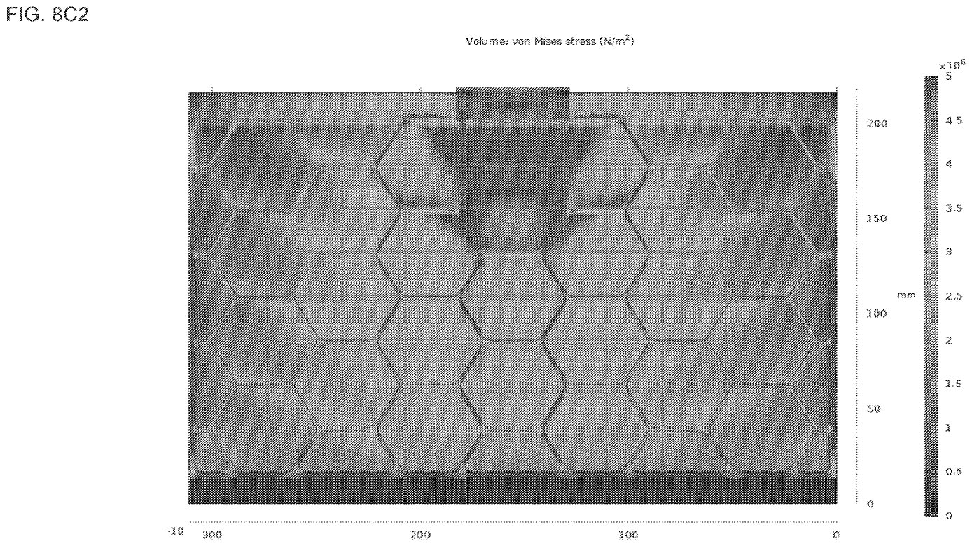

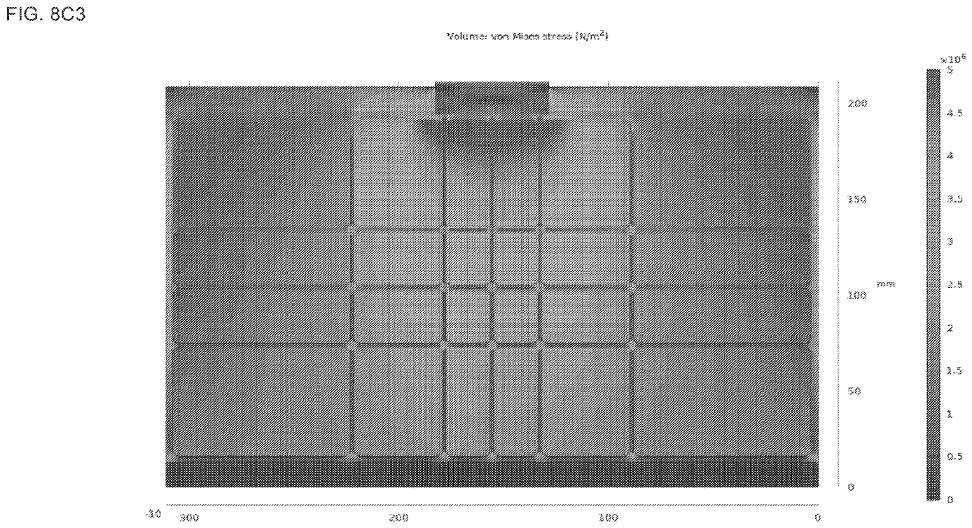

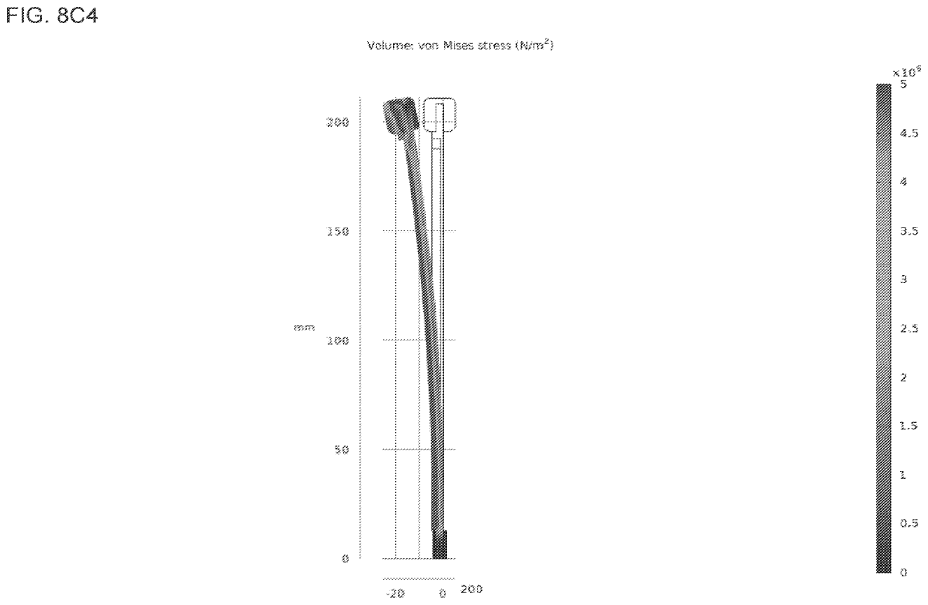

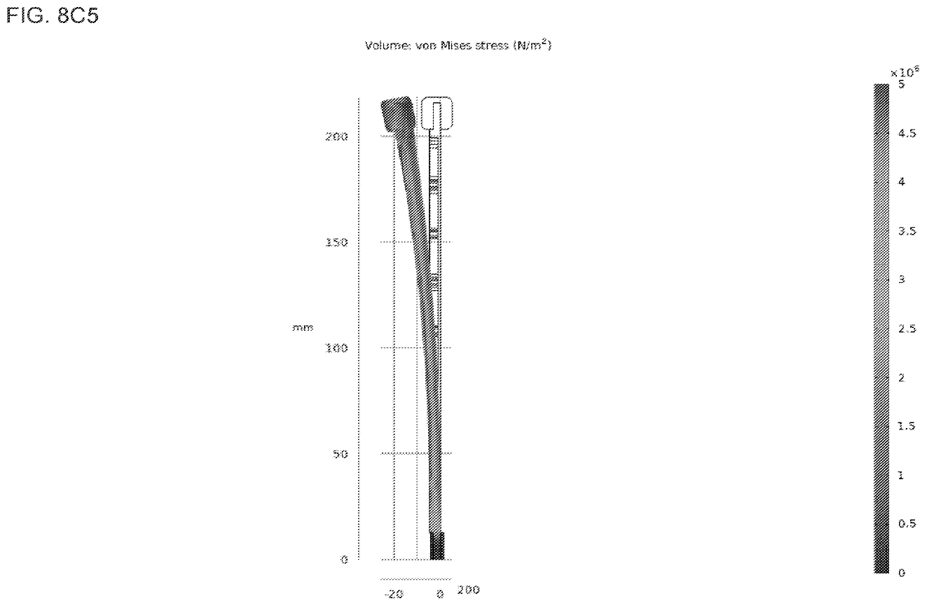

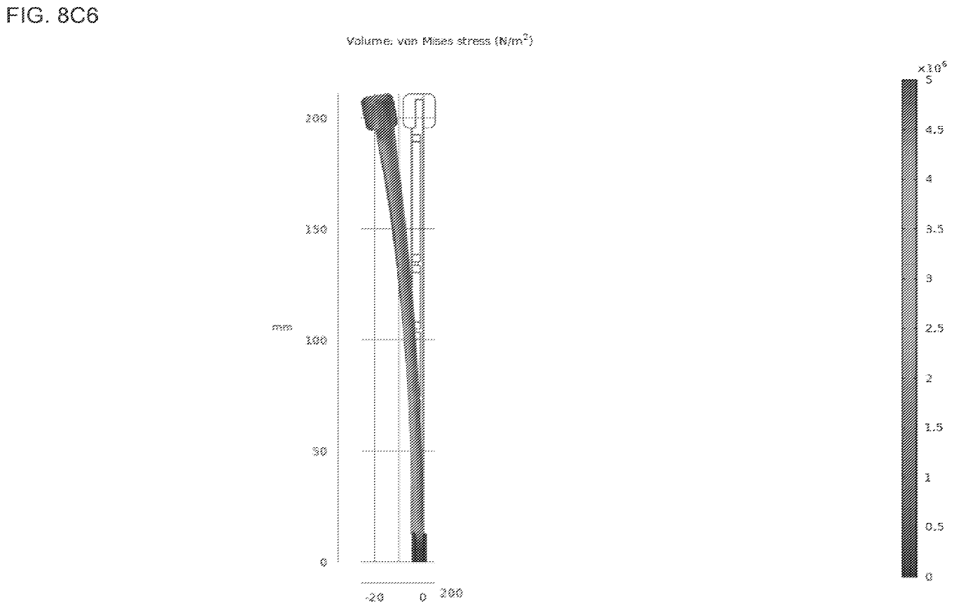

FIGS. 8A1, 8A2, 8A3, 8A4, 8A5, 8A6, 8B1, 8B2, 8B3, 8B4, 8B5, 8B6, 8C1, 8C2, 8C3, 8C4, 8C5, and 8C6 provide data from structural mechanical simulations (e.g., simulations performed using COMSOL) showing stress and/or displacement. The scale used to display stress results is configured such that different shades represent different levels of stress. Stress can be defined as N/m2. The colors in FIG. 8 and/or other figures can be used to indicate whether the stress in a particular region of the model is below, within, or above a specified range. In some embodiments and considering FIG. 8, the scale can indicate that the stress is below a specified minimum stress level (e.g., 1.5 N/m²); the scale can indicate that the stress is within a specified range (e.g., 2 N/m² to 3 N/m²), typically considered as an acceptable level of stress; and/or the scale can indicate that the stress is above a specified maximum stress level (e.g., 4 N/m²), indicating potential failure (e.g., fracture). The side views are indicative of displacement. Displacement can be a measure of the amount of movement or deformation of a point or a region in a structure due to an applied force.

The simulation can be calculated and analyzed using structural mechanics simulation module and the displacement study type can be static, linear or non-linear analysis. The loads and boundary conditions for the simulations can be applied and the results analyzed by comparing the magnitude of the displacement for all boundary forces and wall types.

In some embodiments, a Region of Interest (ROI) can be defined based on the worst results for stress and strain for all wall types and measured using the data subsets from the main analysis. The process of measuring an ROI can involve the following steps: 1—Imported different wall models into simulations software (e.g., COMSOL) and run the stress/strain simulation. 2—select a few ROIs (Region of Interest) based on the highest stress/strain results per wall type. 3—Export a table with the results for stress/strain. 4—Report the worst stress/strain for the ROI. 6—capture the contours and volume plots to display overall results for stress/strain. Results of various example simulations as connected to the steps above are shown in this document.

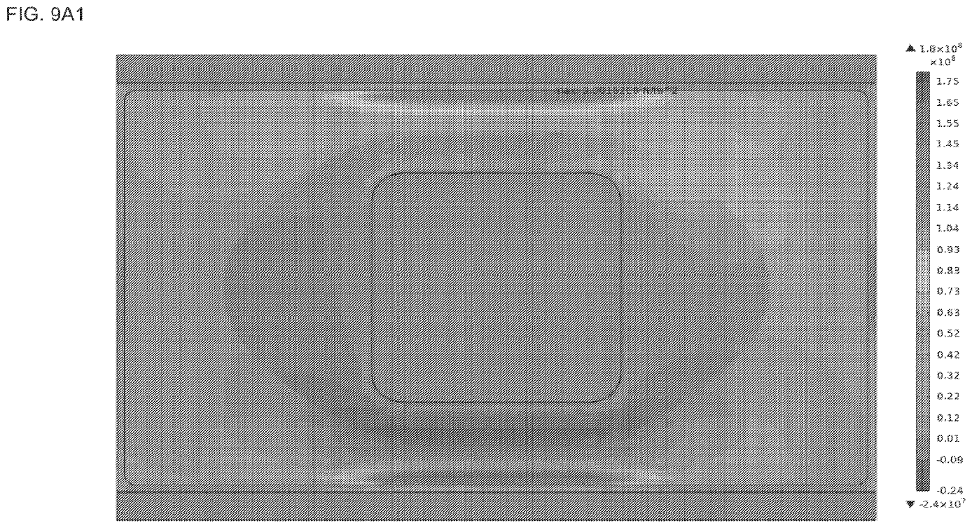

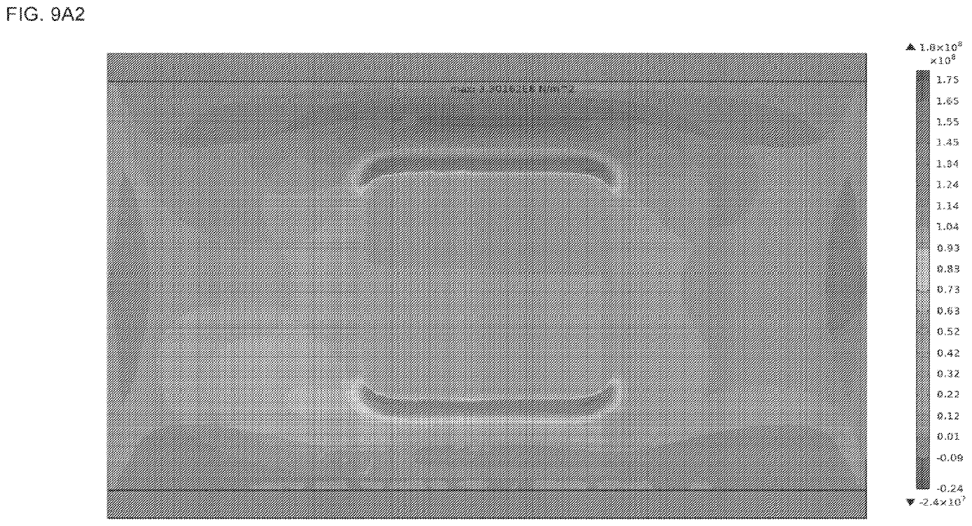

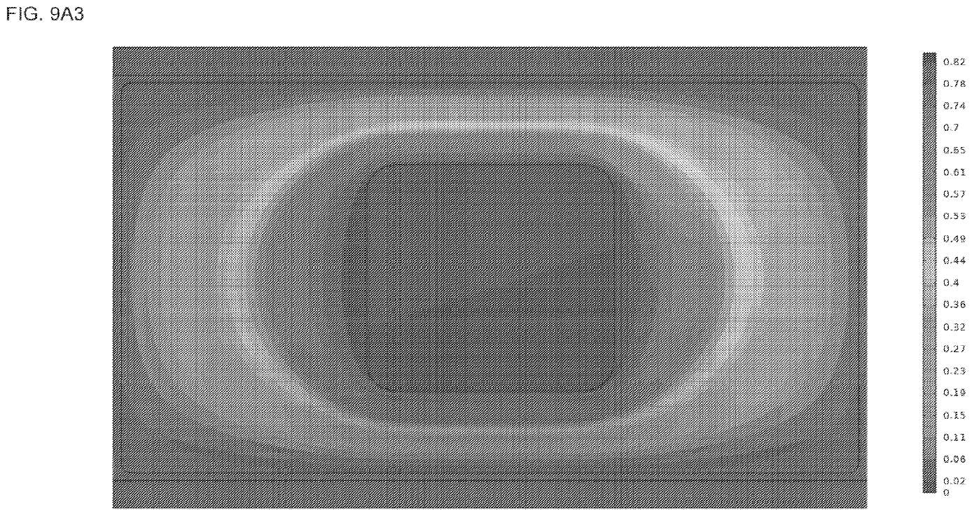

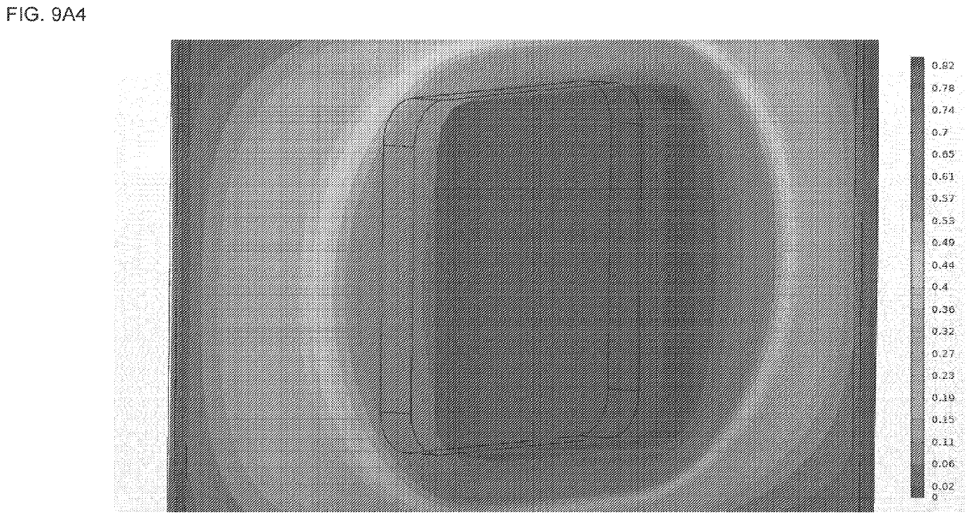

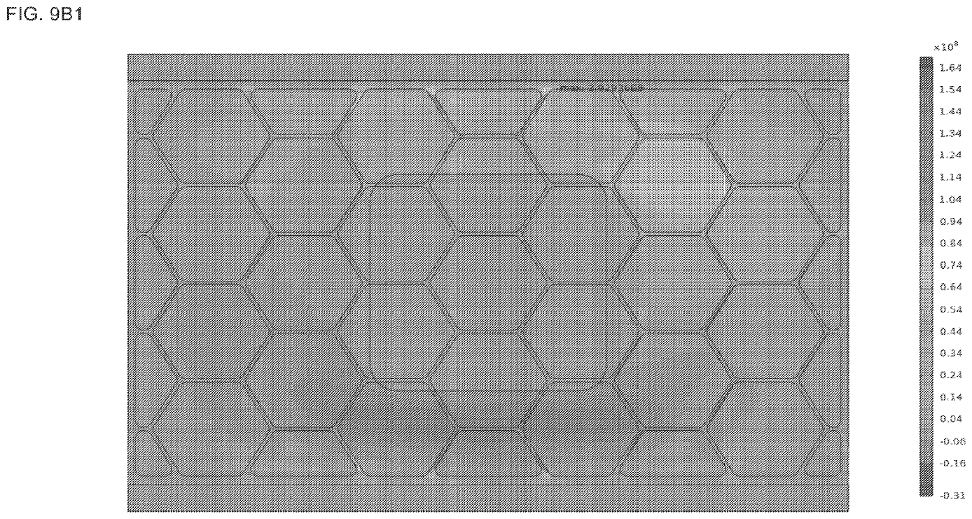

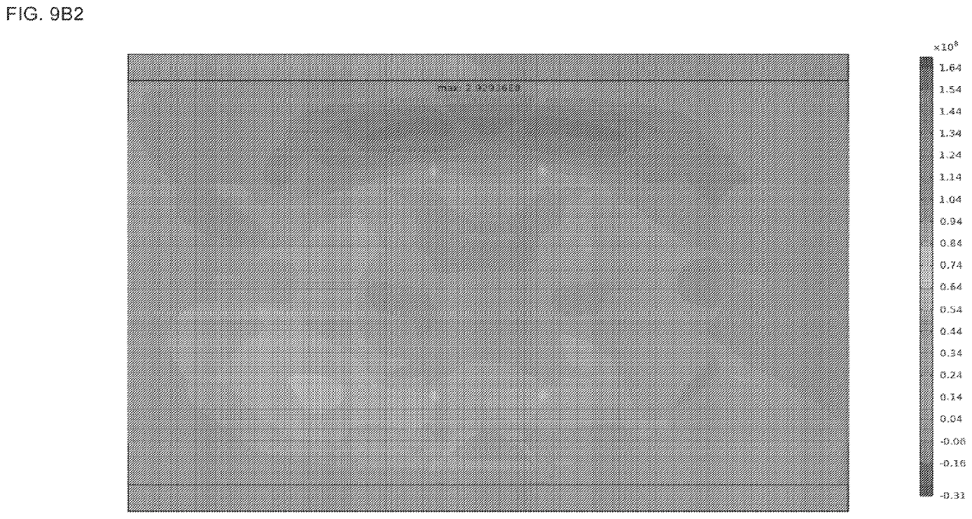

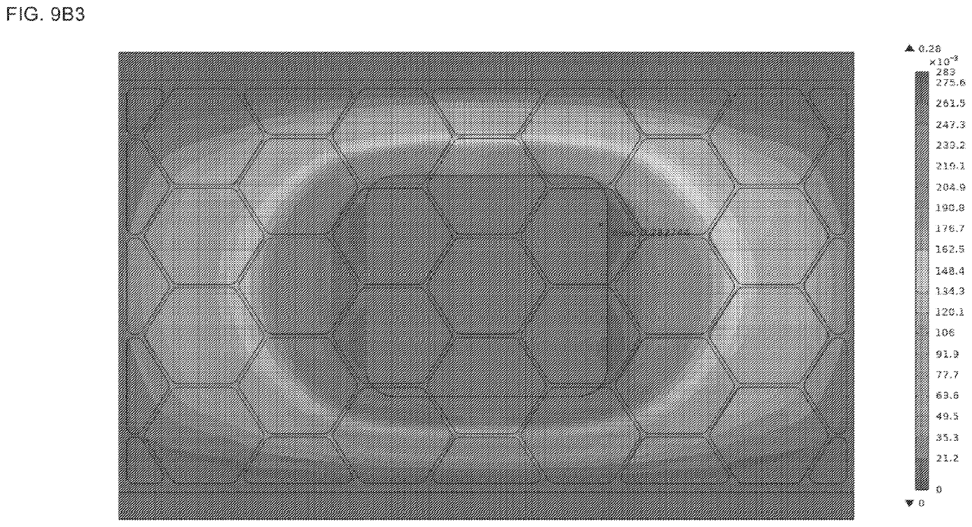

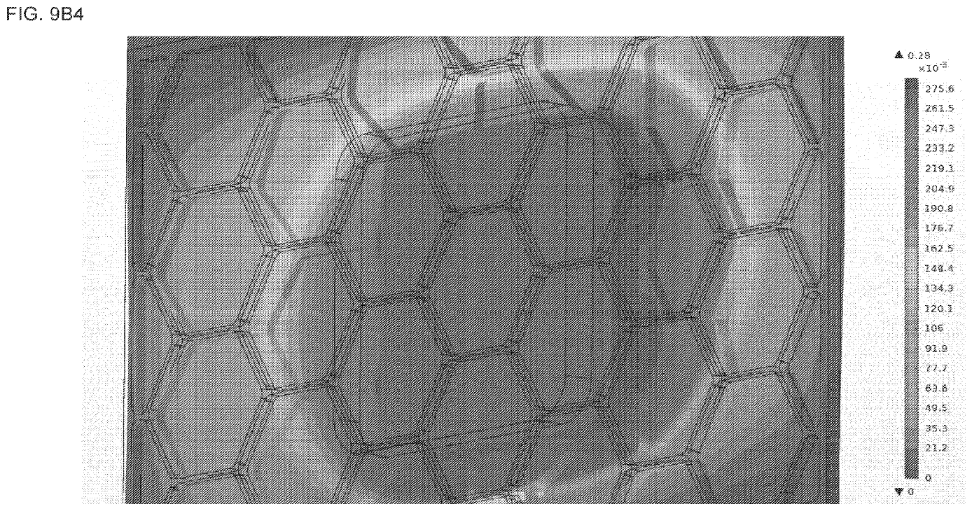

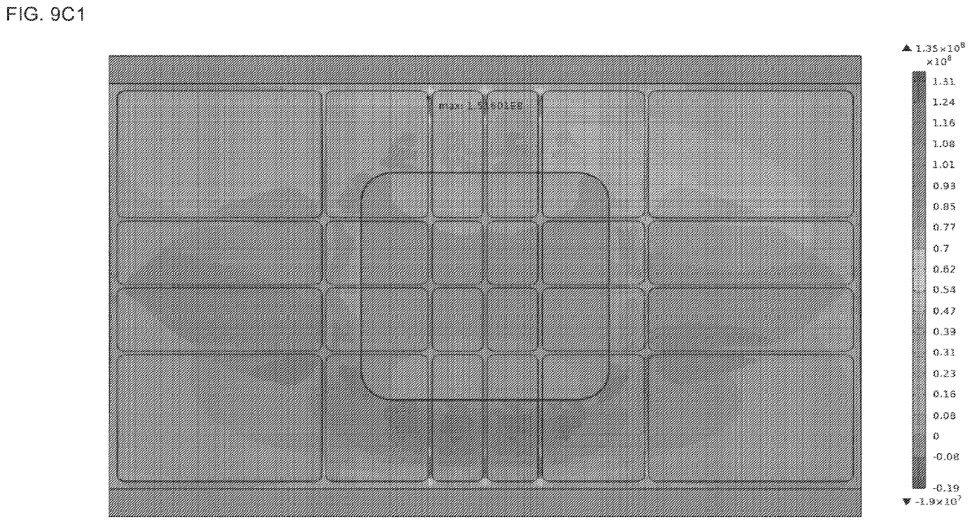

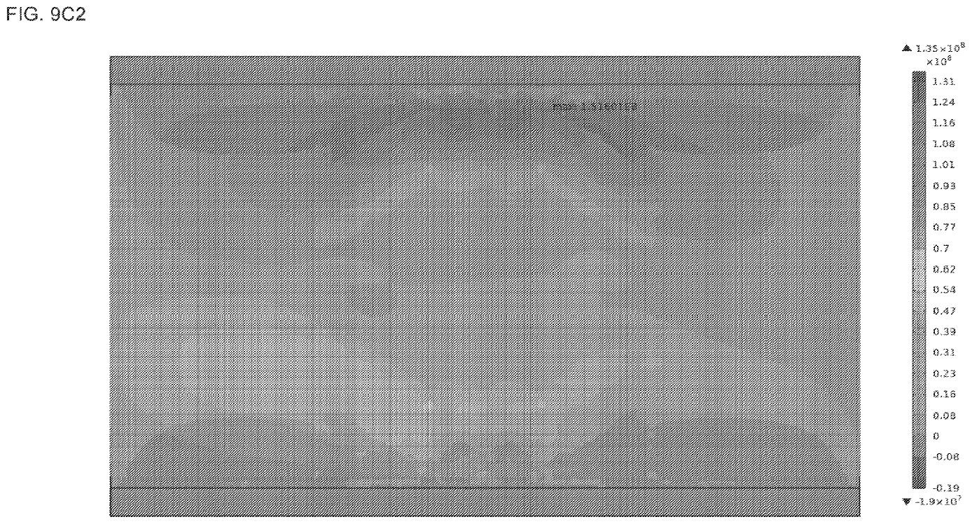

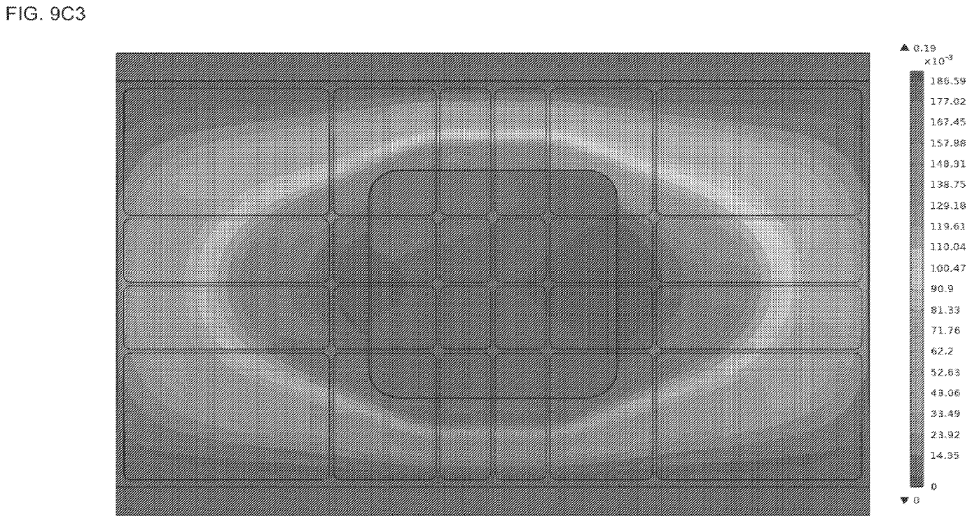

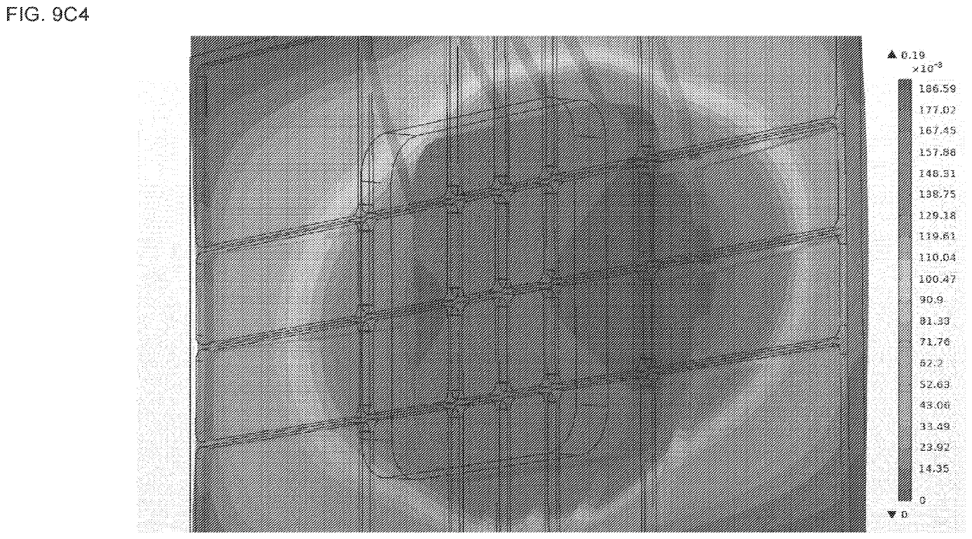

FIGS. 9A1, 9A2, 9A3, 9A4, 9B1, 9B2, 9B3, 9B4, 9C1, 9C2, 9C3, and 9C4 show various example views based on data from structural mechanical simulations (e.g., from COMSOL) showing stress simulations data for a front force applied to a conventional plain wall (FIGS. 9A1, 9A2, 9A3, and 9A4), a conventional hexagonal wall (FIGS. 9B1, 9B2, 9B3, and 9B4), and a variable geometry payload wall in accordance with various embodiments (FIGS. 9C1, 9C2, 9C3, and 9C4). Relatedly, in accordance with some embodiments a payload wall can have around the following performance relative to plain and hexagon designs: plain max stress (N/m²) 3.3016×10⁸, hexagon max stress (N/m²) 2.9294×10⁸, payload wall max stress in accordance with embodiments of the invention (N/m²) 1.5160×10⁸.

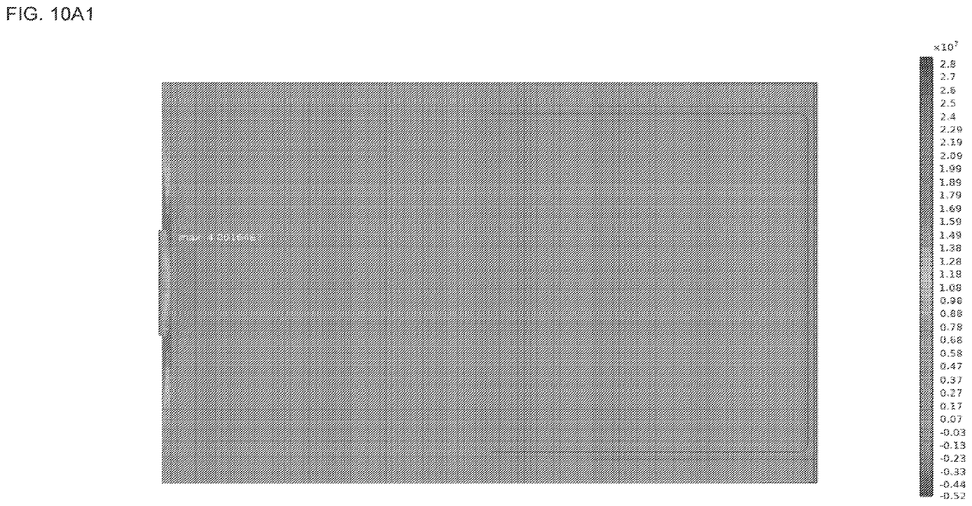

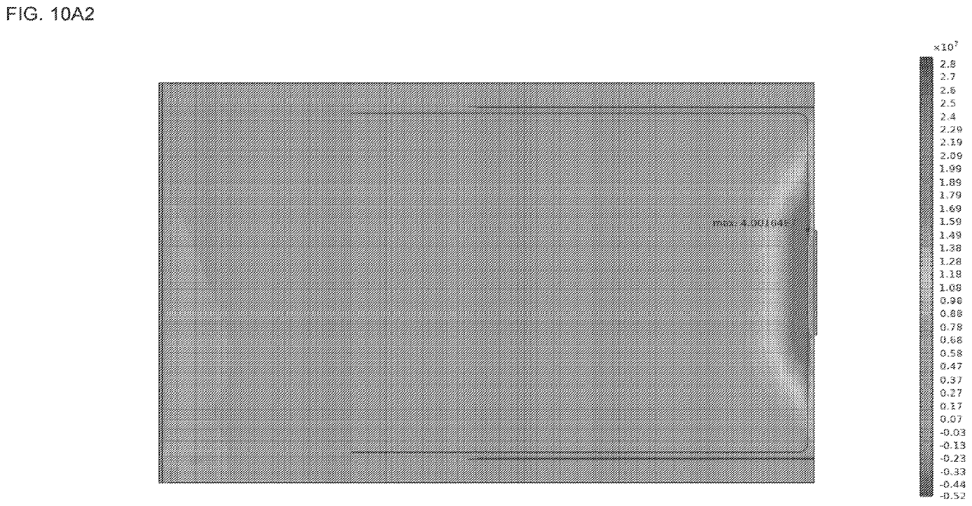

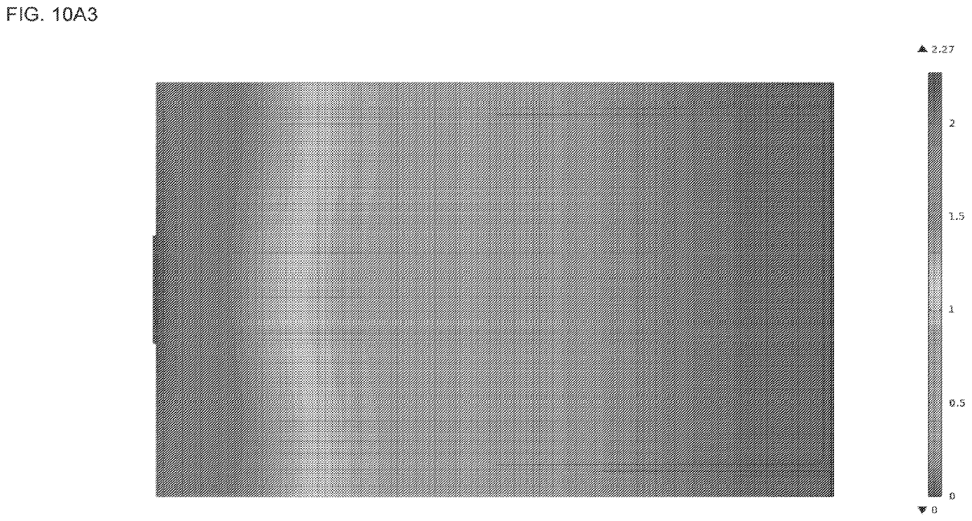

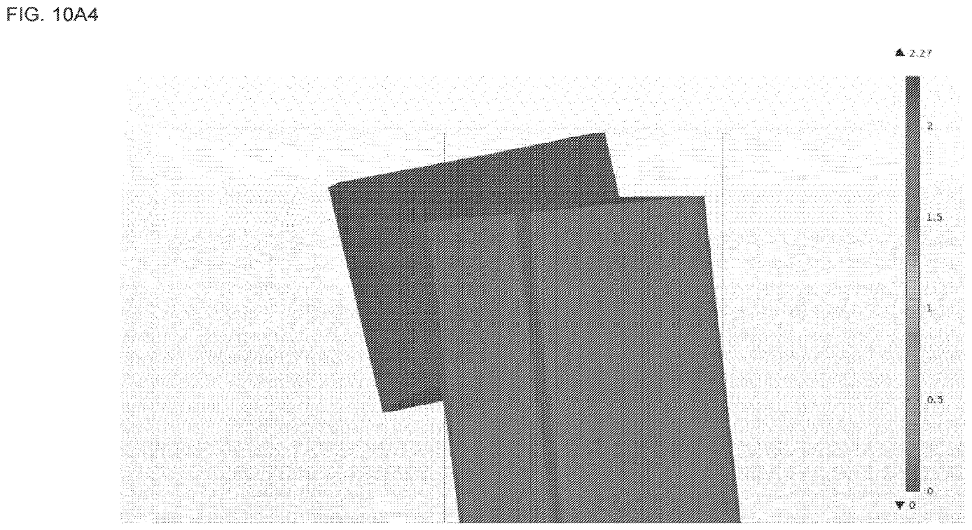

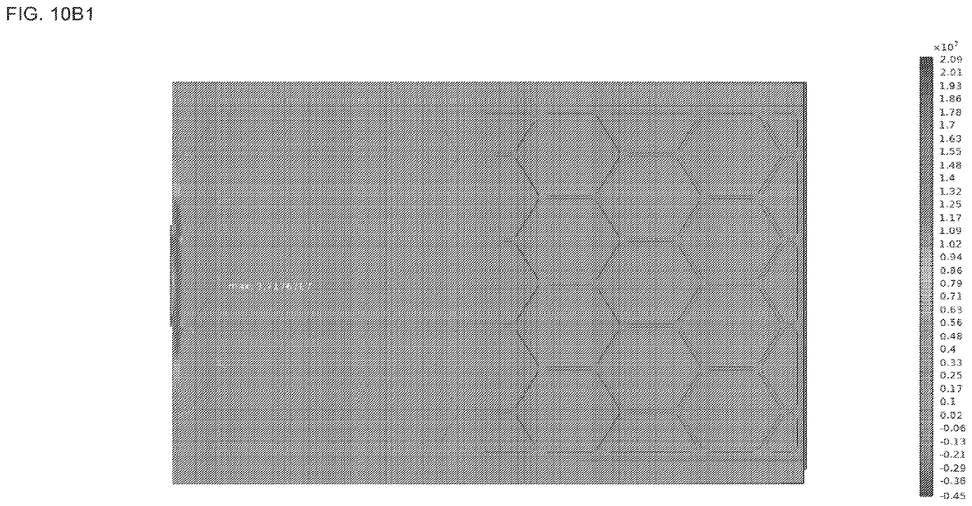

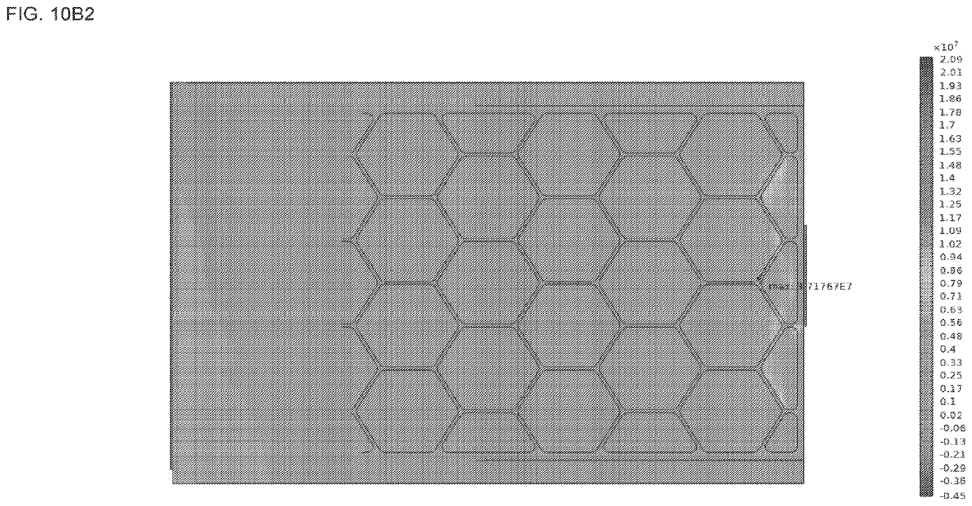

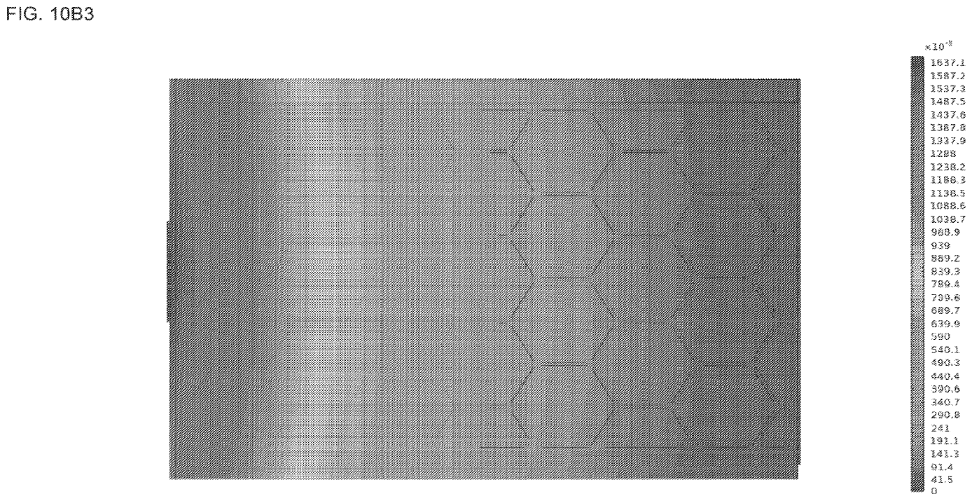

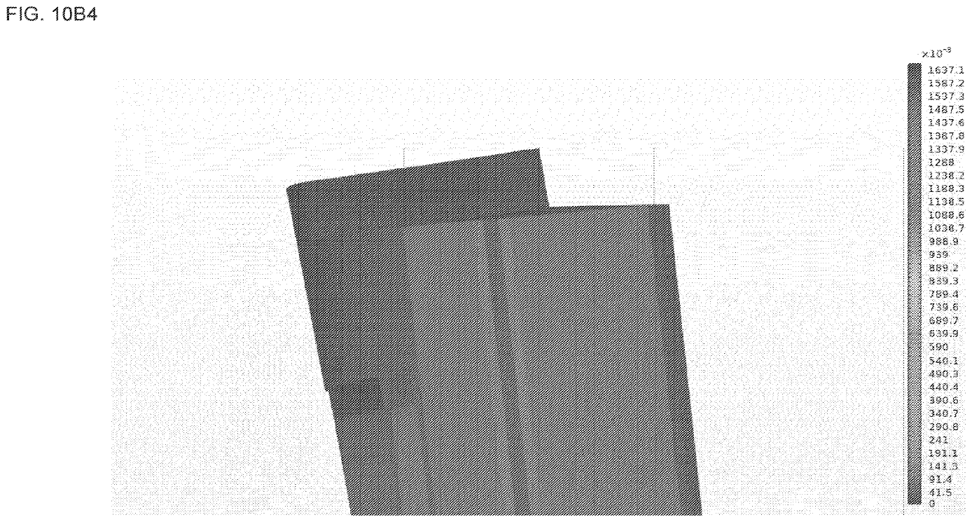

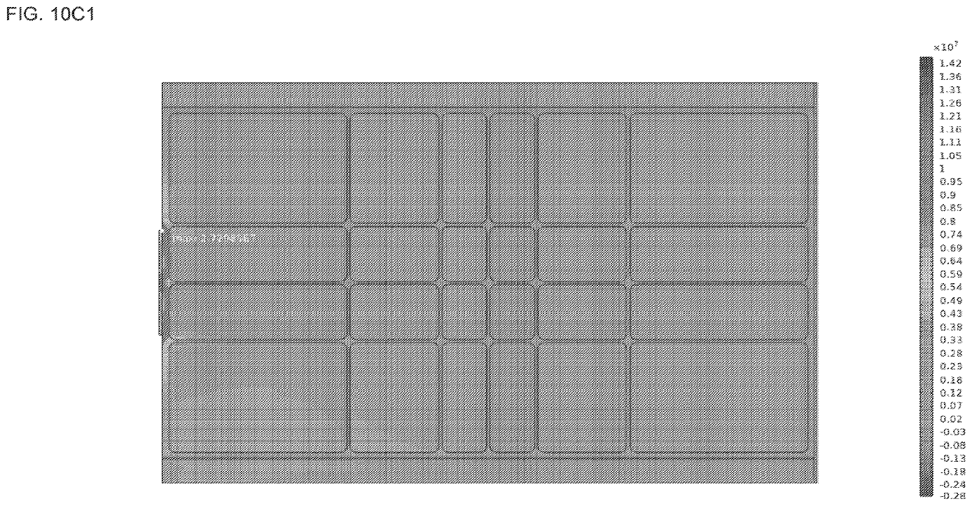

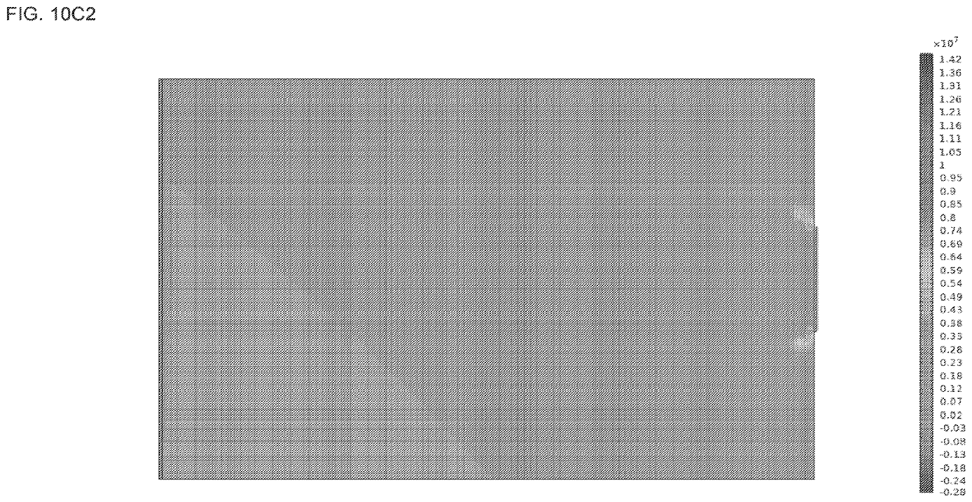

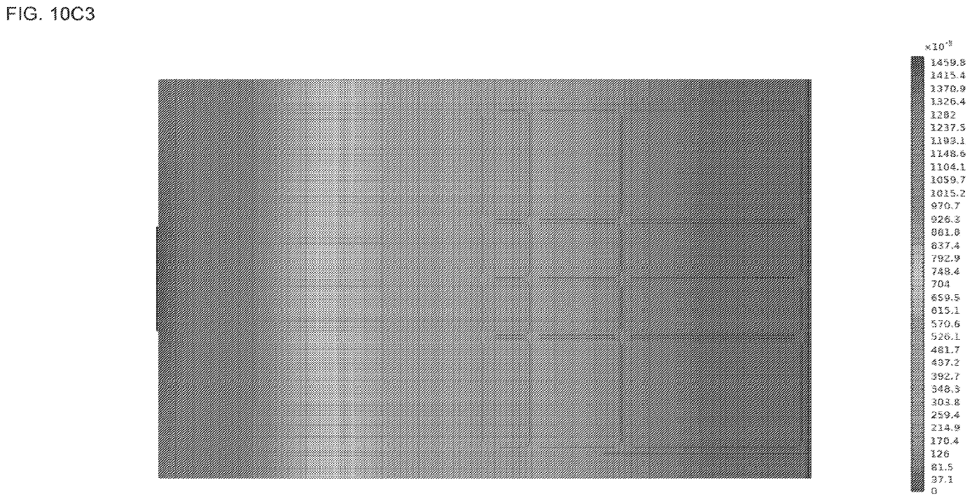

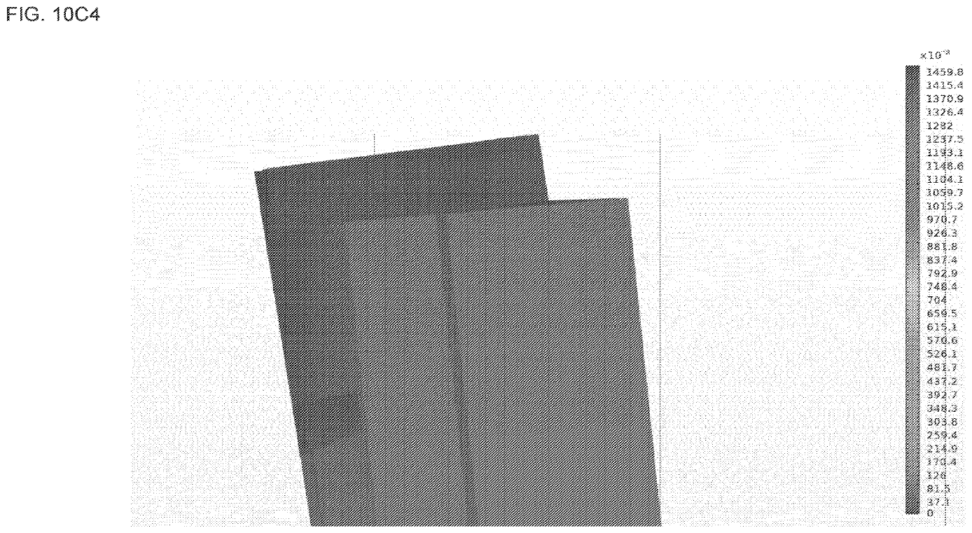

FIGS. 10A1, 10A2, 10A3, 10A4, 10B1, 10B2, 10B3, 10B4, 10C1, 10C2, 10C3, and 10C4 show various example views based on data from structural mechanical simulations (e.g., from COMSOL) showing stress simulations data for a side force applied to a conventional plain wall (FIGS. 10A1, 10A2, 10A3, and 10A4), a conventional hexagonal wall (FIGS. 10B1, 10B2, 10B3, and 10B4) and a variable geometry payload wall in accordance with various embodiments (FIGS. 10C1, 10C2, 10C3, and 10C4). Relatedly, in accordance with some embodiments a payload wall can have around the following performance relative to plain and hexagon designs: plain max stress (N/m²) 4.0016×10⁷, hexagon max stress (N/m²) 3.7177×10⁷, in accordance with embodiments of the invention payload wall max stress (N/m²) 2.729×10⁷.

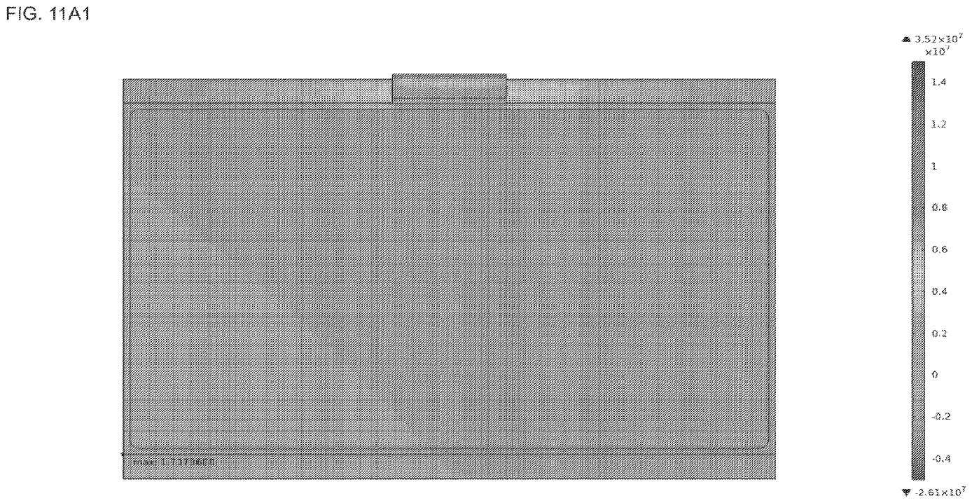

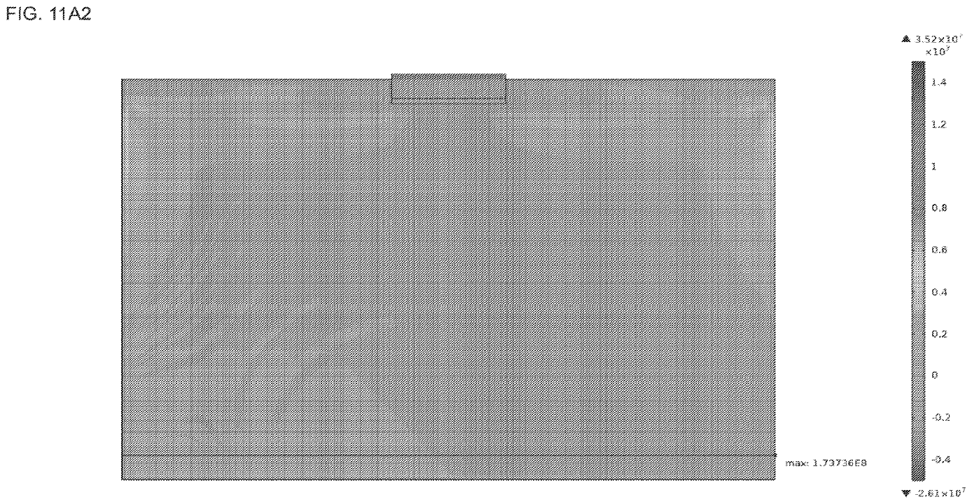

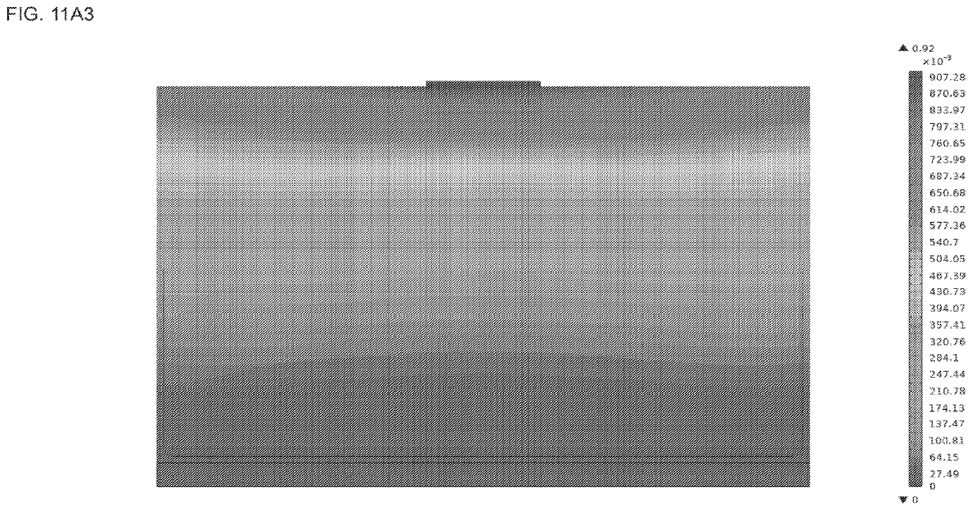

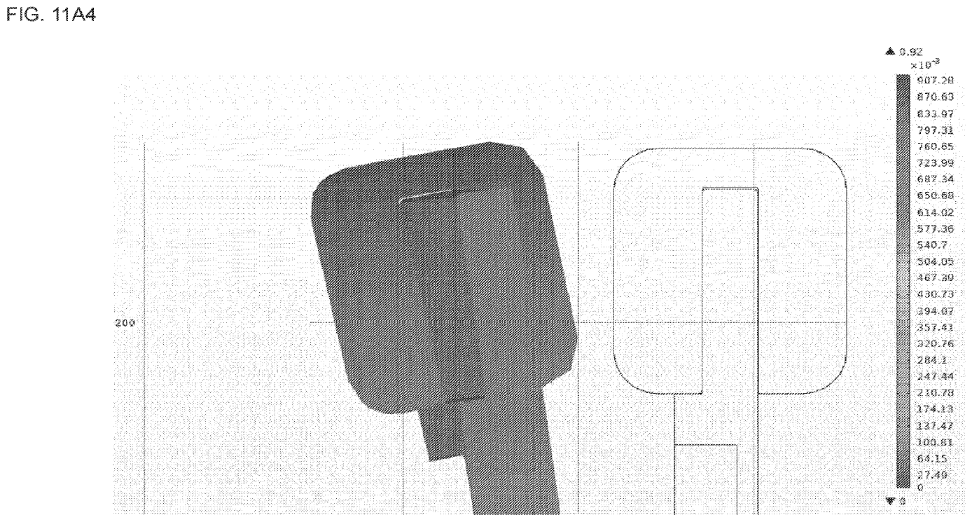

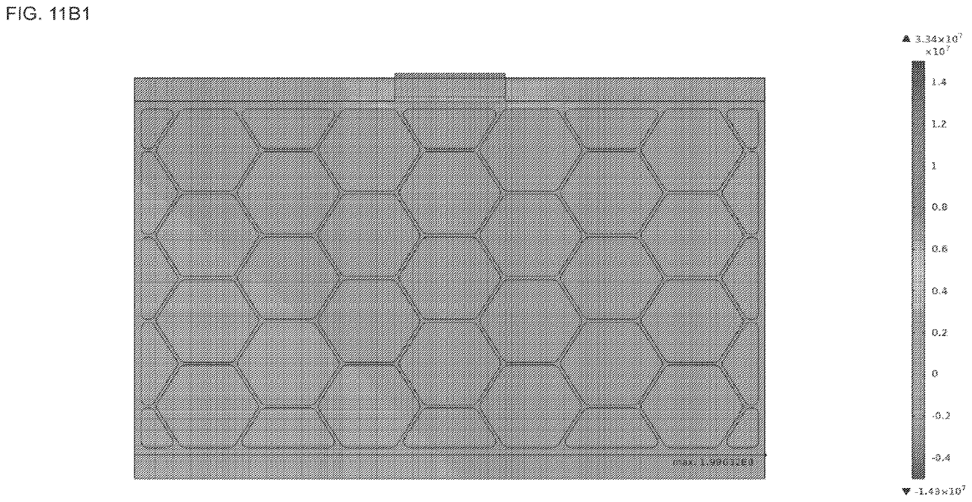

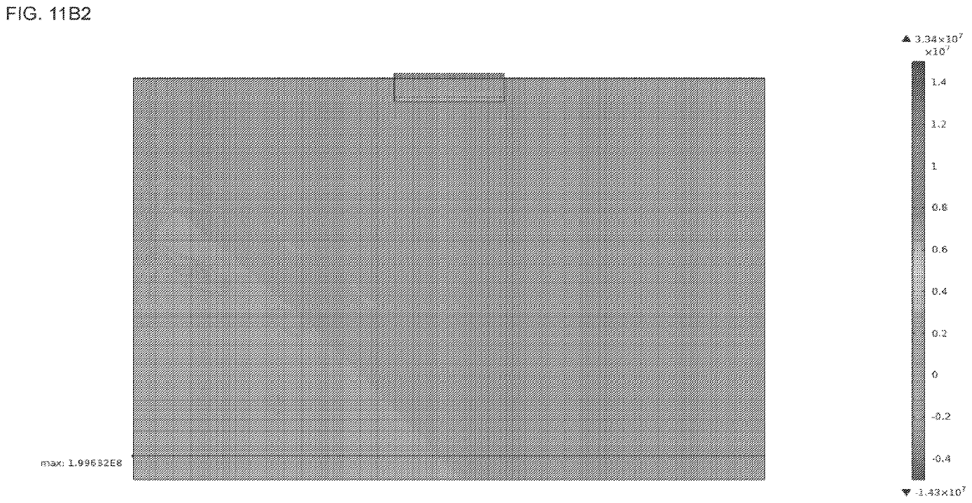

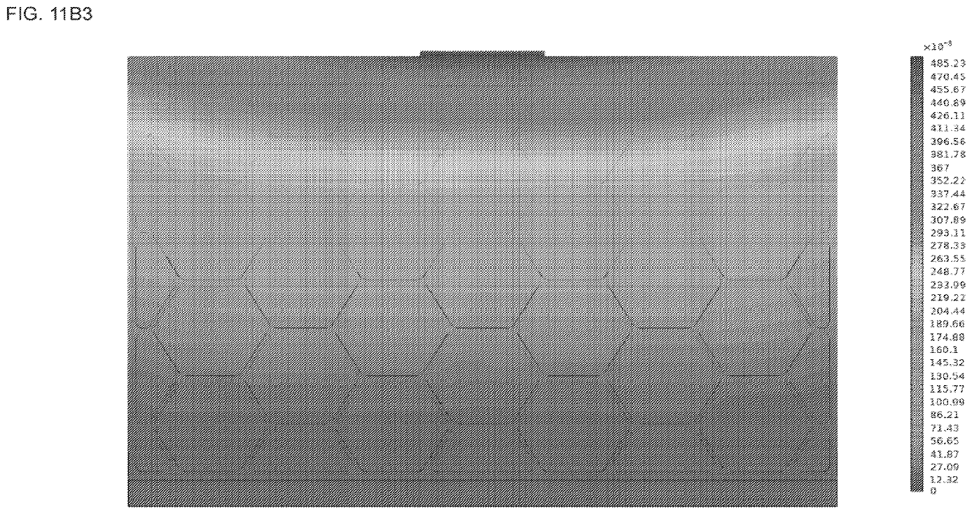

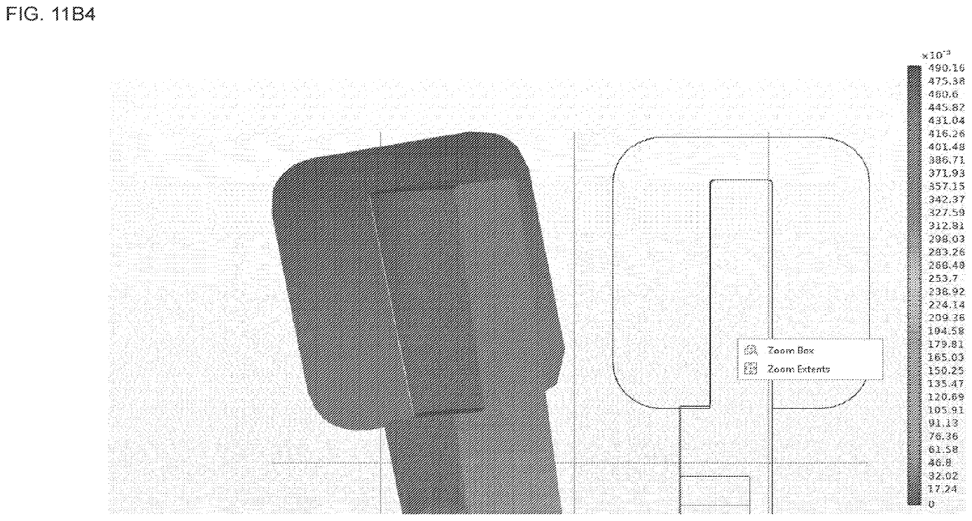

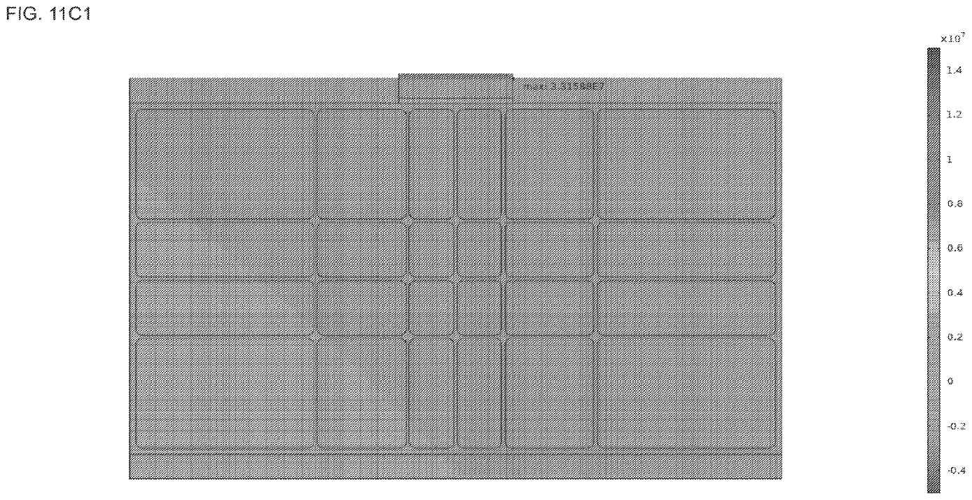

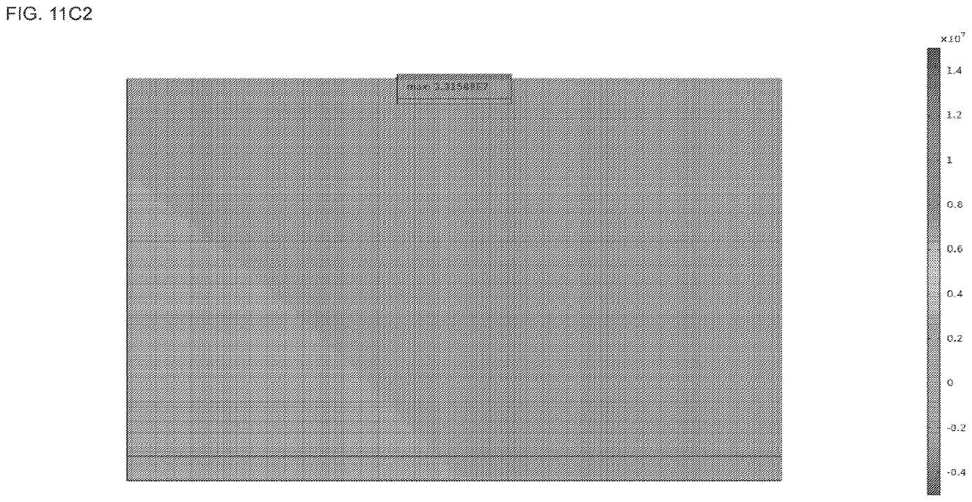

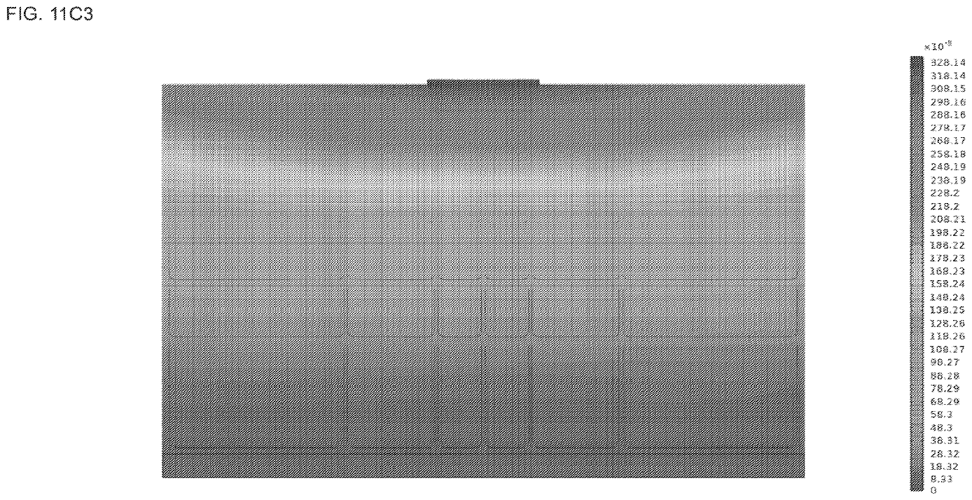

FIGS. 11A1, 11A2, 11A3, 11A4, 11B1, 11B2, 11B3, 11B4, 11C1, 11C2, 11C3, and 11C4 show various example views based on data from structural mechanical simulations (e.g., from COMSOL) showing stress simulations data for a top force applied to a conventional plain wall (FIGS. 11A1, 11A2, 11A3, and 11A4), a conventional hexagonal wall (FIGS. 11B1, 11B2, 11B3, and 11B4) and variable geometry payload wall in accordance with various embodiments (FIGS. 11C1, 11C2, 11C3, and 11C4). Relatedly, in accordance with some embodiments a payload wall can have around the following performance relative to plain and hexagon designs: plain max stress (N/m²) 1.73736×10⁸, hexagon max stress (N/m²) 1.99632×10⁸, payload wall in accordance with embodiments of the invention max stress (N/m²) 3.31588×10⁷.

In each of the above studies the variable geometry payload wall in accordance with various embodiments shows better maximum stress figures compared to conventional payload walls. In addition to force distribution, embodiments can be beneficial for their relative lightweight structure (e.g., lightweight compared to a honeycomb pattern). Several embodiments are an improvement over thin wall for shock protection. Many embodiments are an improvement over using honeycombs since honeycomb designs can increase overall weight without sufficient improvements in force distribution. Total weight comparison and delta are presented below with a clear weight advantage over other patterns.

Example weight comparisons: thin (e.g., plain) wall can have an example weight of around 0.68 lbs, 100% weight to reference; hexagon wall can have an example weight of around 0.77 lbs, 113.24% weight to reference; and the payload wall in accordance with several embodiments of the invention, around 0.71 lbs, around 104.4% weight to reference (e.g., the plain wall).

Payload wall design (e.g., as described throughout this document) can be selected on the following basis: force segmentation, the wall is just a subassembly of the top-level box assembly performance where all forces are supported by the entire box assembly; metal stress distribution, weight, and/or central fragility. progressive rectangle pattern for payload walls in accordance with many embodiments, can distribute applied forces more evenly throughout the entire wall (especially for the top and front stress scenarios), which makes metal fatigue and breakage less likely to occur (relative to plain walls and/or hexagon walls). Various embodiments offer a good compromise in terms of weight and structural strength. Several embodiments are around 4.4% heavier than the lighter thin wall configuration while providing superior central support for top and front stress loads. Numerous embodiments show that a progressive rectangular pattern as described through this specification can reduce central stresses to improve central fragility of the payload wall.

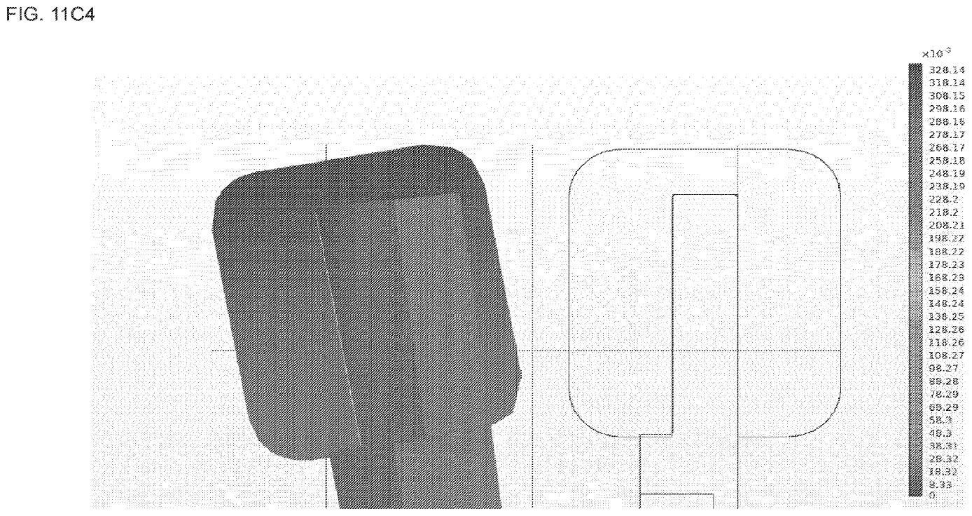

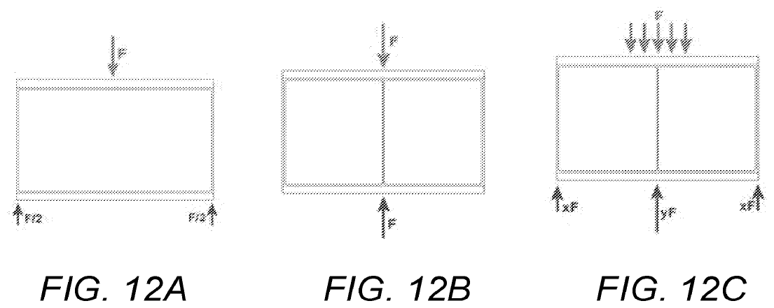

FIGS. 12A through 12C are force diagrams of an exemplary payload wall with supports. When a plain aluminum sheet is subjected to a force in the top middle (F-red arrows), the force will be split in half to each one of the sides (FIG. 12A). When the wall had a central support structure and the force applied was exactly the same (top middle), then the force would be supported entirely by the central structure (FIG. 12B) when using the assumption that there is no horizontal structure that can distribute the force across the top surface. When the force applied is not in one single point, but distributed across the surface, then the forces will be divided proportionally based on the distance to the vertical supports (FIG. 12C).

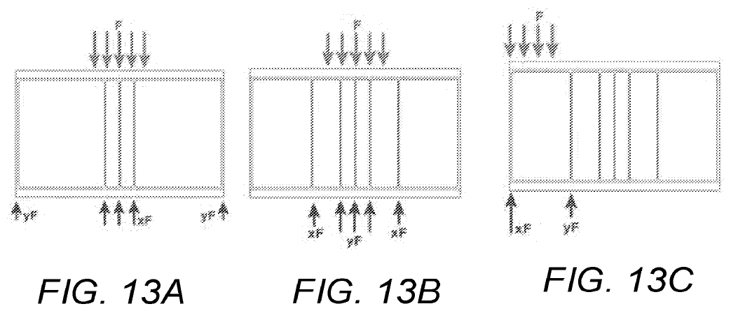

FIGS. 13A through 13C are force diagrams of an example payload wall with supports and a distributed applied force. Since the weakest point in a plain wall is the middle top, the center support is under greater mechanical stress. One solution would be to create multiple vertical structures equally spaced horizontally and the same size as the side supports, but this would make the wall very heavy. In order to reduce wall weight, a progressive square and/or rectangle design can have multiple vertical supports (e.g., columns, and/or struts) much thinner than the sides' supports. Such a design can provide better support for forces applied far from the sides (e.g., as shown in FIG. 13A). Since the side support is thicker than the center support, as the force gets closer to the side, there is less need to have supports towards the center, so the spacing between the center supports can increase (e.g., as shown in FIG. 13B). As the force shifts to the side, most of the force is supported by the side structure, thus the center structure can be thinner and lighter (e.g., as shown in FIG. 13C). The same concept illustrated in FIGS. 12A to 12C and FIGS. 13A to 13C can be applied to forces applied to the sides and front of the plate.

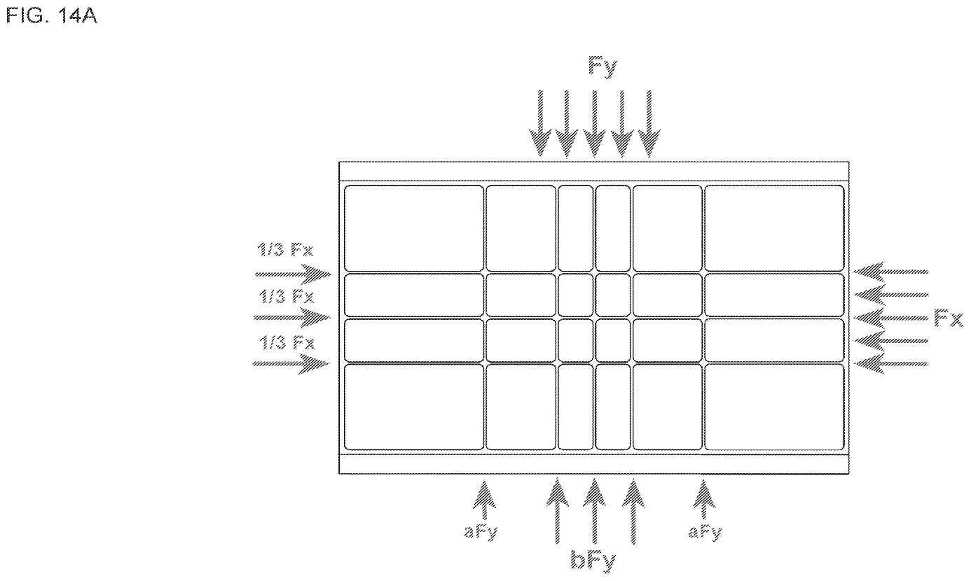

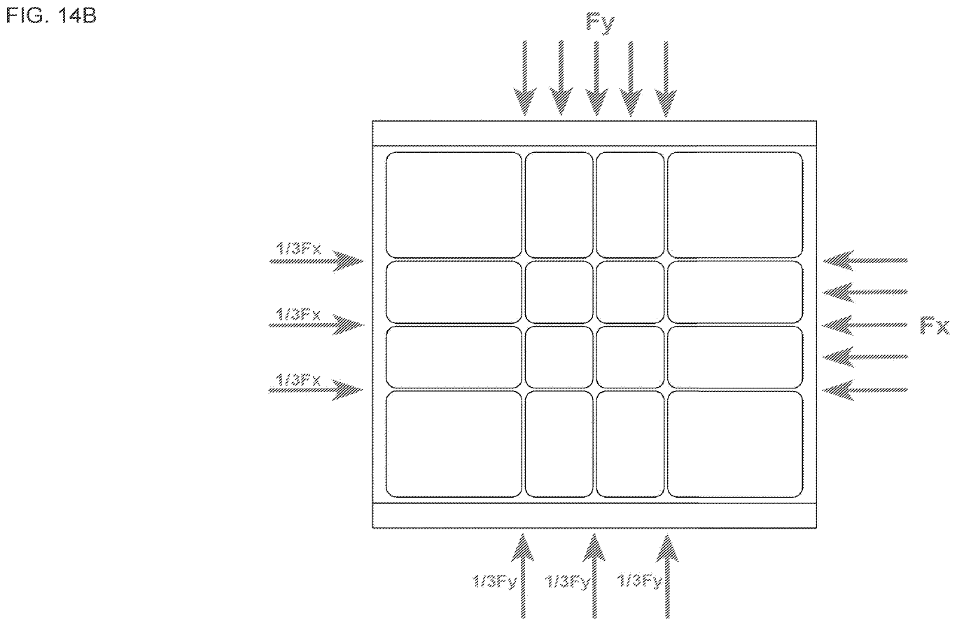

FIGS. 14A through 14B are force diagrams of an example wall with progressive square supports in two directions and distributed applied forces. A consideration can be, that depending on the size of the wall compared to the size of the force, there might need to be more or less central supports (e.g., as shown in FIG. 14A). The progressive square design methodology is transferable to other shape structures (e.g., a square, and as shown in FIG. 14B). Accordingly, in accordance with many embodiments, a payload's internal structure can include a main support structure for the box assembly that is made of 1″ solid 7075 aluminum bar and/or ¼″ 7075 aluminum plates. These components can provide great support in the event of any stress forces from the sides or top close to the edges. In numerous embodiments, payload walls walls can be machined from 3/16″ 7075 aluminum plate.

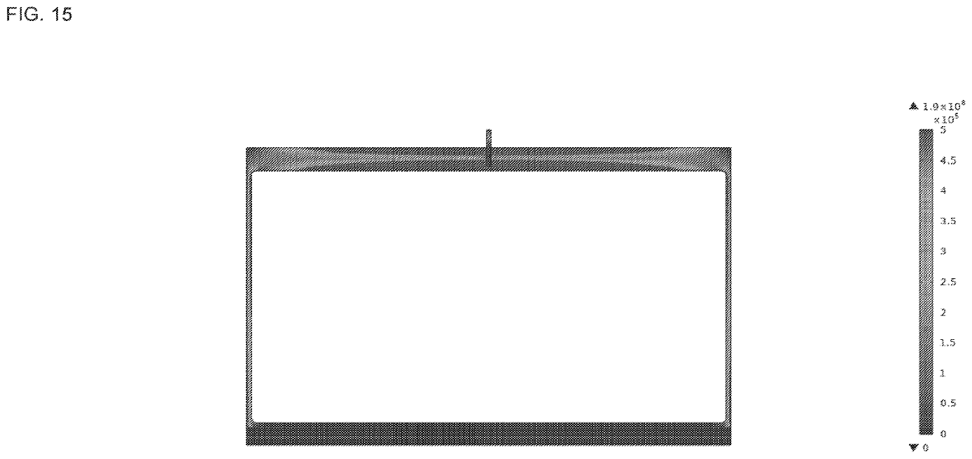

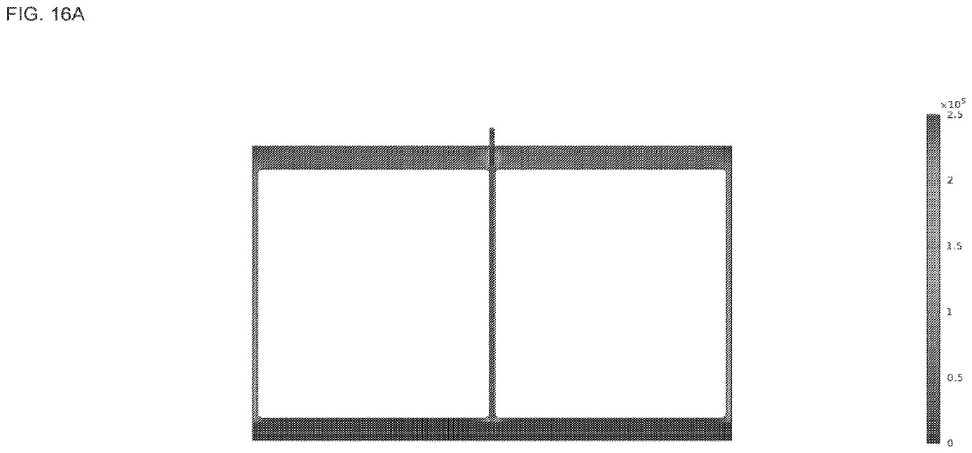

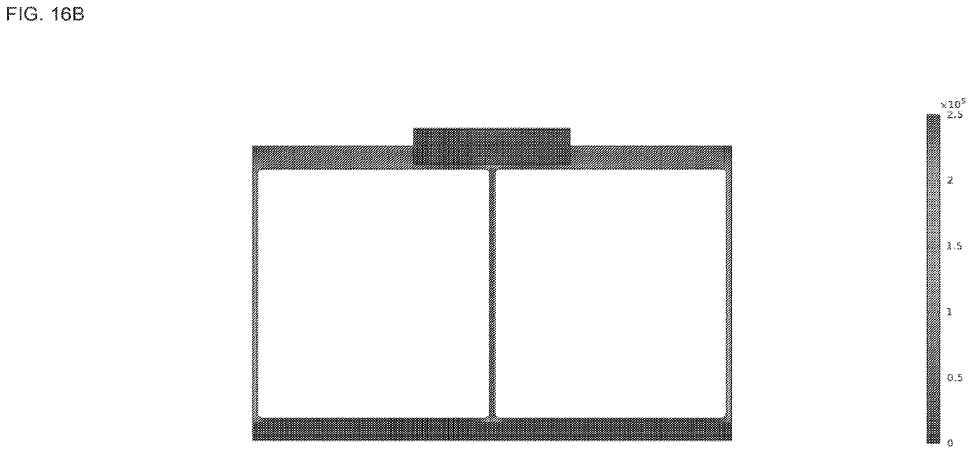

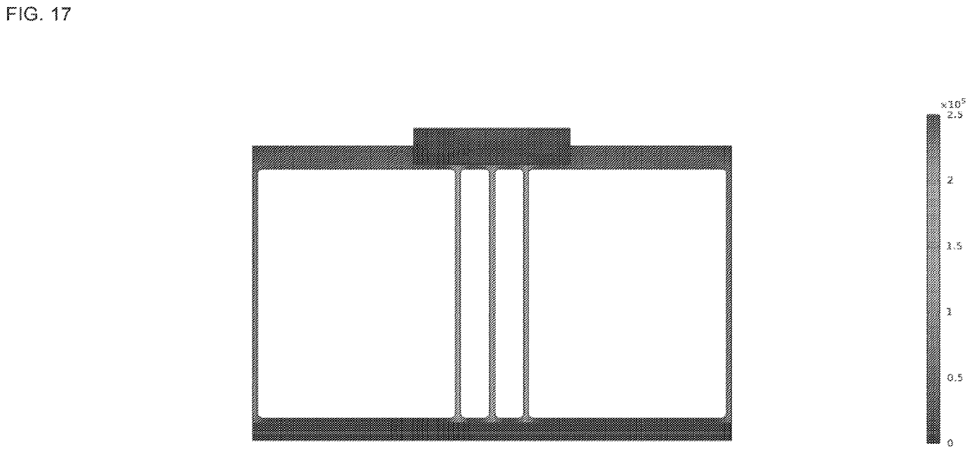

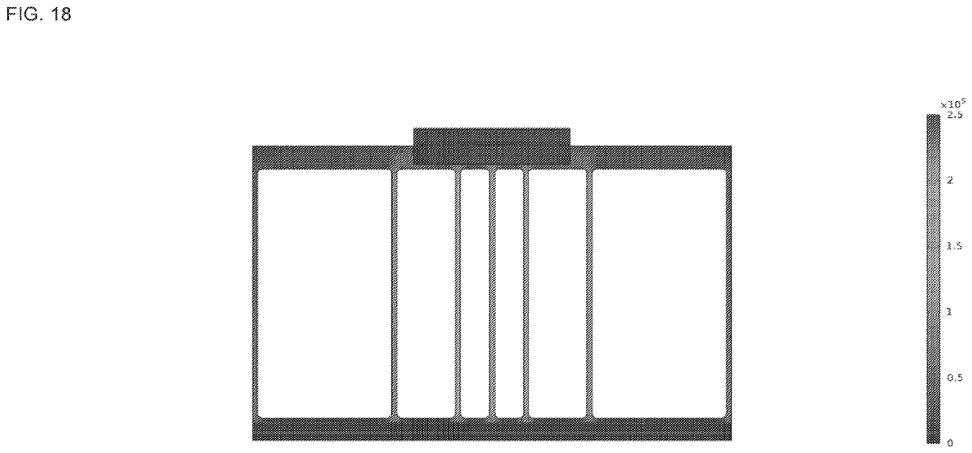

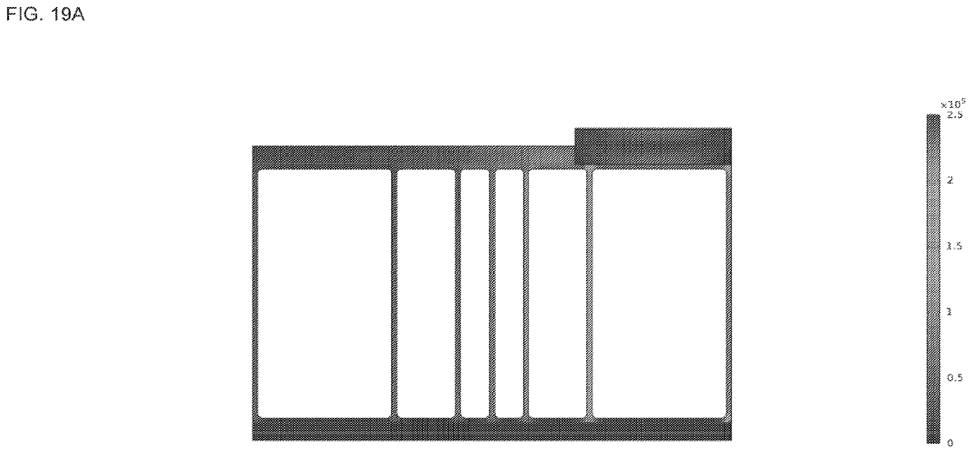

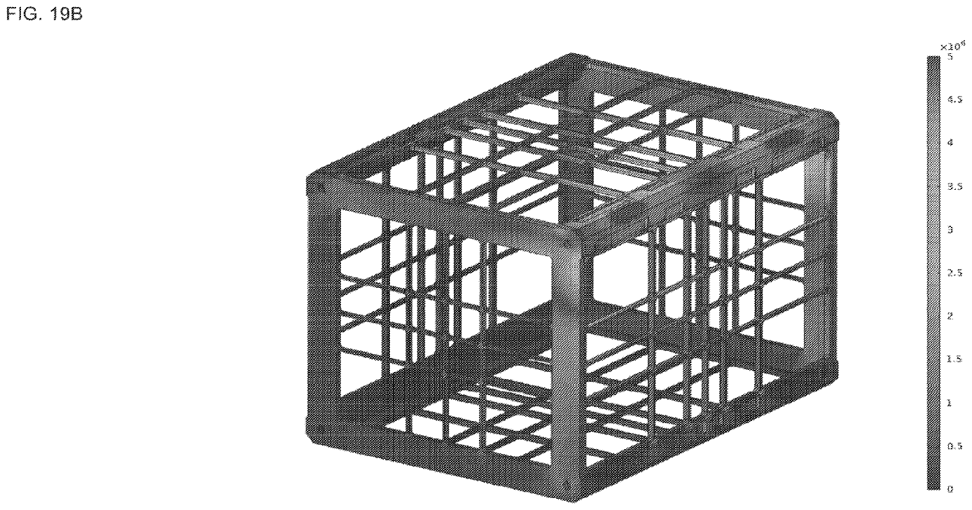

Many of the following figures show simulations of a wall with just vertical supports to show the force distribution effect amongst the vertical structure. Generally, in these figures, the load is applied on the middle of the top structure towards the bottom. The simulations and the figures represented example data from such simulations show the response with single to multiple columns to applied forces. FIG. 15 shows an example distribution for stress in response to a point load on a payload wall with no columns. FIG. 16A and FIG. 16B respectively show example distributions for stress in response to a point load and a distributed load on a payload wall with one column. FIG. 17 shows an example distribution for stress in response to a distributed load on a payload wall with three columns. FIG. 18 shows an example distribution for stress in response to a distributed load on a payload wall with five columns. FIGS. 19A through 19B respectively show example distributions for stress in response to an offset distributed load on a payload wall with five columns and a payload with other walls shown. This demonstrates that the distribution of forces via a variable geometry payload wall in accordance with embodiments can more efficiently distribute forces with a good balance of weight to strength.

### Example Embodiments

Clause 1. A payload structure for in-space use, the payload structure comprising: a first payload wall comprising: an outer structure defining a quadrilateral inner area, the inner area spanned by a sheet; a central column structure centrally aligned to and spanning the sheet; and an offset column structure offset from the central column structure towards a first side such that a first distance between the central column structure and the offset column structure is less than a second distance between the offset column structure and a generally parallel portion of the outer structure on the first side. Clause 2. The payload structure of clause 1, wherein the central column structure has a smaller width dimension that the outer structure.

Clause 3. The payload structure of clause 1, wherein the central column structure has a smaller width dimension that the outer structure.

Clause 4. The payload structure of clause 1, the payload structure further comprising a second offset column structure, the second offset column structure offset from the central column structure towards a second side such that a third distance between the central column structure and the second offset column structure is less than a fourth distance between the second offset column structure and a second generally parallel portion of the outer structure on the second side, the second side opposite the first side.

Clause 5. The payload structure of clause 1, the payload structure further comprising a second offset column structure, the second offset column structure offset from the central column structure towards the first side such that the first distance between the central column structure and the offset column structure is less than a third distance between the offset column structure and the second offset column structure, and wherein the third distance is less than a fourth distance from the second offset column structure to the generally parallel portion of the outer structure on the first side.

Clause 6. The payload structure of clause 1, the payload structure further comprising a central strut structure, the central strut structure centrally aligned to and spanning the sheet, and the central strut structure is generally perpendicular to the central column structure.

Clause 7. The payload structure of clause 6, wherein the central strut structure has a smaller width dimension that the outer structure.

Clause 8. The payload structure of clause 6, the payload structure further comprising an offset strut structure offset from the central strut structure towards a first side such that a fifth distance between the central strut structure and the offset strut structure is less than a sixth distance between the central strut structure and a generally parallel portion of the outer structure on a third side.

Clause 9. The payload structure of clause 8, the payload structure further comprising a second offset strut structure, the second offset strut structure offset from the central strut structure towards a fourth side such that a seventh distance between the central strut structure and the second offset strut structure is less than an eighth distance between the central strut structure and a fourth generally parallel portion of the outer structure on the fourth side, the fourth side opposite the third side.

Clause 10. The payload structure of clause 8, the payload structure further comprising a second offset strut structure, the second offset strut structure offset from the central strut structure towards the third side such that a ninth distance between the central strut structure and the first offset strut structure is less than a tenth distance between the first offset strut structure and the second offset strut structure, and wherein the tenth distance is less than an eleventh distance from the second offset strut structure to the generally parallel portion of the outer structure.

Clause 11. A payload wall for in-space use, the payload wall comprising: an outer structure defining a quadrilateral inner area, the inner area spanned by a sheet; a central column structure centrally aligned to and spanning the sheet; and an offset column structure offset from the central column structure towards a first side such that a first distance between the central column structure and the offset column structure is less than a second distance between the offset column structure and a generally parallel portion of the outer structure on the first side.

Clause 12. The payload wall of clause 11, wherein the central column structure has a smaller width dimension that the outer structure.

Clause 13. The payload wall of clause 11, wherein the central column structure has a smaller width dimension that the outer structure.

Clause 14. The payload wall of clause 11, the payload wall further comprising a second offset column structure, the second offset column structure offset from the central column structure towards a second side such that a third distance between the central column structure and the second offset column structure is less than a fourth distance between the second offset column structure and a second generally parallel portion of the outer structure on the second side, the second side opposite the first side.

Clause 15. The payload wall of clause 11, the payload wall further comprising a second offset column structure, the second offset column structure offset from the central column structure towards the first side such that the first distance between the central column structure and the offset column structure is less than a third distance between the offset column structure and the second offset column structure, and wherein the third distance is less than a fourth distance from the second offset column structure to the generally parallel portion of the outer structure on the first side.

Clause 16. The payload wall of clause 11, the payload wall further comprising a central strut structure, the central strut structure centrally aligned to and spanning the sheet, and the central strut structure is generally perpendicular to the central column structure.

Clause 17. The payload wall of clause 16, wherein the central strut structure has a smaller width dimension that the outer structure.

Clause 18. The payload wall of clause 16, the payload wall further comprising an offset strut structure offset from the central strut structure towards a first side such that a fifth distance between the central strut structure and the offset strut structure is less than a sixth distance between the central strut structure and a generally parallel portion of the outer structure on a third side.

Clause 19. The payload wall of clause 18, the payload wall further comprising a second offset strut structure, the second offset strut structure offset from the central strut structure towards a fourth side such that a seventh distance between the central strut structure and the second offset strut structure is less than an eighth distance between the central strut structure and a fourth generally parallel portion of the outer structure on the fourth side, the fourth side opposite the third side.

Clause 20. The payload wall of clause 18, the payload wall further comprising a second offset strut structure, the second offset strut structure offset from the central strut structure towards the third side such that a ninth distance between the central strut structure and the first offset strut structure is less than a tenth distance between the first offset strut structure and the second offset strut structure, and wherein the tenth distance is less than an eleventh distance from the second offset strut structure to the generally parallel portion of the outer structure.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1 %, less than or equal to ±0.5%, less than or equal to ±0.1 %, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A payload structure for in-space use, the payload structure comprising:
a first payload wall comprising:
an outer structure defining a quadrilateral inner area, the inner area spanned by a sheet;
a central column structure centrally aligned to and spanning the sheet; and
an offset column structure offset from the central column structure towards a first side such that a first distance between the central column structure and the offset column structure is less than a second distance between the offset column structure and a generally parallel portion of the outer structure on the first side.

2. The payload structure of claim 1, wherein the central column structure has a smaller width dimension that the outer structure.

3. The payload structure of claim 1, wherein the central column structure has a smaller width dimension that the outer structure.

4. The payload structure of claim 1, the payload structure further comprising a second offset column structure, the second offset column structure offset from the central column structure towards a second side such that a third distance between the central column structure and the second offset column structure is less than a fourth distance between the second offset column structure and a second generally parallel portion of the outer structure on the second side, the second side opposite the first side.

5. The payload structure of claim 1, the payload structure further comprising a second offset column structure, the second offset column structure offset from the central column structure towards the first side such that the first distance between the central column structure and the offset column structure is less than a third distance between the offset column structure and the second offset column structure, and wherein the third distance is less than a fourth distance from the second offset column structure to the generally parallel portion of the outer structure on the first side.

6. The payload structure of claim 1, the payload structure further comprising a central strut structure, the central strut structure centrally aligned to and spanning the sheet, and the central strut structure is generally perpendicular to the central column structure.

7. The payload structure of claim 6, wherein the central strut structure has a smaller width dimension that the outer structure.

8. The payload structure of claim 6, the payload structure further comprising an offset strut structure offset from the central strut structure towards a first side such that a fifth distance between the central strut structure and the offset strut structure is less than a sixth distance between the central strut structure and a generally parallel portion of the outer structure on a third side.

9. The payload structure of claim 8, the payload structure further comprising a second offset strut structure, the second offset strut structure offset from the central strut structure towards a fourth side such that a seventh distance between the central strut structure and the second offset strut structure is less than an eighth distance between the central strut structure and a fourth generally parallel portion of the outer structure on the fourth side, the fourth side opposite the third side.

10. The payload structure of claim 8, the payload structure further comprising a second offset strut structure, the second offset strut structure offset from the central strut structure towards the third side such that a ninth distance between the central strut structure and the first offset strut structure is less than a tenth distance between the first offset strut structure and the second offset strut structure, and wherein the tenth distance is less than an eleventh distance from the second offset strut structure to the generally parallel portion of the outer structure.

11. A payload wall for in-space use, the payload wall comprising:
an outer structure defining a quadrilateral inner area, the inner area spanned by a sheet;
a central column structure centrally aligned to and spanning the sheet; and
an offset column structure offset from the central column structure towards a first side such that a first distance between the central column structure and the offset column structure is less than a second distance between the offset column structure and a generally parallel portion of the outer structure on the first side.

12. The payload wall of claim 11, wherein the central column structure has a smaller width dimension that the outer structure.

13. The payload wall of claim 11, wherein the central column structure has a smaller width dimension that the outer structure.

14. The payload wall of claim 11, the payload wall further comprising a second offset column structure, the second offset column structure offset from the central column structure towards a second side such that a third distance between the central column structure and the second offset column structure is less than a fourth distance between the second offset column structure and a second generally parallel portion of the outer structure on the second side, the second side opposite the first side.

15. The payload wall of claim 11, the payload wall further comprising a second offset column structure, the second offset column structure offset from the central column structure towards the first side such that the first distance between the central column structure and the offset column structure is less than a third distance between the offset column structure and the second offset column structure, and wherein the third distance is less than a fourth distance from the second offset column structure to the generally parallel portion of the outer structure on the first side.

16. The payload wall of claim 11, the payload wall further comprising a central strut structure, the central strut structure centrally aligned to and spanning the sheet, and the central strut structure is generally perpendicular to the central column structure.

17. The payload wall of claim 16, wherein the central strut structure has a smaller width dimension that the outer structure.

18. The payload wall of claim 16, the payload wall further comprising an offset strut structure offset from the central strut structure towards a first side such that a fifth distance between the central strut structure and the offset strut structure is less than a sixth distance between the central strut structure and a generally parallel portion of the outer structure on a third side.

19. The payload wall of claim 18, the payload wall further comprising a second offset strut structure, the second offset strut structure offset from the central strut structure towards a fourth side such that a seventh distance between the central strut structure and the second offset strut structure is less than an eighth distance between the central strut structure and a fourth generally parallel portion of the outer structure on the fourth side, the fourth side opposite the third side.

20. The payload wall of claim 18, the payload wall further comprising a second offset strut structure, the second offset strut structure offset from the central strut structure towards the third side such that a ninth distance between the central strut structure and the first offset strut structure is less than a tenth distance between the first offset strut structure and the second offset strut structure, and wherein the tenth distance is less than an eleventh distance from the second offset strut structure to the generally parallel portion of the outer structure.
